(19) United States
(12) Patent Application Publication
(10) Pub. No.: US 2026/0076504 A1
(43) Pub. Date: Mar. 19, 2026

(54) MODULAR ESPRESSO BREWING SYSTEM

(71) Applicant: Daniel Jason Ratner, San Francisco, CA (US)

(72) Inventor: Daniel Jason Ratner, San Francisco, CA (US)

(21) Appl. No.: 19/327,187

(22) Filed: Sep. 12, 2025

Related U.S. Application Data
(60) Provisional application No. 63/695,306, filed on Sep. 16, 2024.

(51) Int. Cl. A47J 31/36; A47J 31/42; A47J 31/44; A47J 31/54; F24H 1/16

(52) U.S. Cl. CPC A47J 31/3671; A47J 31/42; A47J 31/4489; A47J 31/542; F24H 1/162; A47J 2201/00; A47J 2202/00

(57) ABSTRACT

In one embodiment, an apparatus includes a first module and a second module. The first module includes a first receptacle and a second receptacle, the first receptacle being configured to contain a liquid and a second receptacle being configured to contain coffee beans. The first module further includes a heating arrangement, the heating arrangement being at least partially positioned between the first receptacle and the second receptacle. The second module is configured to support the first module and to provide power to the heating arrangement when the first module is supported on the second module.

### CROSS-REFERENCE TO RELATED APPLICATION

This patent application claims the benefit of priority under 35 U.S.C. § 119 to U.S. Provisional Patent Application No. 63/695,306, filed Sep. 16, 2024, and entitled “ESPRESSO MAKER,” which is incorporated herein by reference in its entirety.

### TECHNICAL FIELD

The present disclosure relates generally to devices for preparing coffee beverages, and more specifically to a modular system for preparing espresso beverages.

### BACKGROUND

Espresso is a concentrated coffee beverage that is brewed from ground coffee beans by forcing hot water under a relatively high pressure through the coffee beans. Espresso makers or machines are typically used to brew espresso. Many espresso makers, especially “high end” espresso makers, may be complicated to manipulate. Further, high end espresso makers often include intricate mechanisms which may be difficult to maintain and, hence, difficult to repair.

### BRIEF DESCRIPTION OF THE DRAWINGS

The disclosure will be readily understood by the following detailed description in conjunction with the accompanying drawings in which:

FIG. 1A is a diagrammatic perspective representation of a modular espresso brewing system in accordance with an embodiment.

FIG. 1B is a diagrammatic cross-sectional perspective representation of a modular espresso brewing system, e.g., modular espresso brewing system 100 of FIG. 1, in accordance with an embodiment,

FIG. 2A is a block diagram representation of a modular espresso brewing system in accordance with an embodiment.

FIG. 2B is a block diagram representation of a pressure arrangement, e.g., pressure arrangement 216a of FIG. 2A, in accordance with an embodiment.

FIG. 2C is a block diagram representation of a sensor system, e.g., sensor system 216c of FIG. 2A, in accordance with an embodiment.

FIG. 2D is a block diagram representation of a heating arrangement, e.g., heating arrangement 216d of FIG. 2A, in accordance with an embodiment.

FIG. 3 is a process flow diagram which illustrates a method of utilizing a modular espresso brewing system in accordance with an embodiment.

FIG. 4A is a diagrammatic side-view representation of a modular espresso brewing system in a first orientation in accordance with an embodiment.

FIG. 4B is a diagrammatic side-view representation of a modular espresso brewing system, e.g., modular espresso brewing system 400 of FIG. 4A, in accordance with an embodiment.

FIG. 5 is a diagrammatic cross-sectional side-view representation of a modular espresso brewing system accordance with an embodiment.

FIG. 6 is a diagrammatic representation of a modular espresso brewing system in use in accordance with an embodiment.

FIG. 7A is a diagrammatic cross-sectional representation of an espresso brewing module which includes a portafilter arrangement with a heating element in accordance with an embodiment.

FIG. 7B is a diagrammatic cross-sectional representation of a portion of an espresso brewing module which includes a portafilter arrangement, e.g., espresso brewing module 716 of FIG. 7A, with a heating element in accordance with an embodiment.

FIG. 7C is a diagrammatic representation of a heating coil assembly, e.g., heating arrangement 770 or a heating coil assembly of FIGS. 7A and 7B, in accordance with an embodiment.

FIG. 8 is a diagrammatic perspective representation of a heating coil assembly with a conical coil in accordance with an embodiment.

FIG. 9 is a block diagram representation of a portafilter in accordance with an embodiment.

FIG. 10 is a block diagram representation of a modular espresso brewing system, e.g., modular espresso brewing system 200 of FIG. 2A, which includes accessory modules in accordance with an embodiment.

FIG. 11 is a diagrammatic representation of a modular espresso brewing system which is arranged to support an espresso brewing module in a storage orientation in accordance with an embodiment.

FIG. 12 is a process flow diagram which illustrates a method of utilizing intelligence associated with a modular espresso brewing system in accordance with an embodiment.

FIG. 13A is a diagrammatic representation of a puck screen in accordance with an embodiment.

FIG. 13B is a diagrammatic zoomed in representation of a portion of a puck screen that includes a thermocouple, e.g., puck screen 1374 of FIG. 13A, in accordance with an embodiment.

FIG. 14A is a diagrammatic perspective representation of a bottom portion or a cylinder of a brewing module in accordance with an embodiment.

FIG. 14B is a diagrammatic side-view representation of a bottom portion or a cylinder of a brewing module, e.g., brewing module 1416-1 of FIG. 14A, in accordance with an embodiment.

FIG. 14C is a diagrammatic cross-sectional representation of a bottom portion or a cylinder of a brewing module, e.g., brewing module 1416-1 of FIGS. 14A and 14B, in accordance with an embodiment.

FIG. 15A is a diagrammatic perspective top view representation of a heating arrangement in accordance with an embodiment.

FIG. 15B is a diagrammatic perspective bottom view representation of a heating arrangement, e.g., heating arrangement 1570 of FIG. 15A, in accordance with an embodiment.

FIG. 15C is a diagrammatic partial representation of a heating arrangement, e.g., heating arrangement 1570 of FIGS. 15A and 15B, in accordance with an embodiment.

FIG. 16 is a diagrammatic representation of a heating arrangement which includes a thermocouple assembly in accordance with an embodiment.

FIG. 17 is a diagrammatic side view representation of a heating arrangement which includes a thermocouple and is assembled to a bottom portion of a brewing module in accordance with an embodiment.

FIG. 18A is a first view of a portafilter assembly in accordance with an embodiment.

FIG. 18B is a second view of a portafilter assembly, e.g., portafilter assembly 1816-2 of FIG. 18A, in accordance with an embodiment.

FIG. 19 is a diagrammatic cross-sectional side-view representation of a modular espresso brewing system which includes a heating arrangement which may screw into a portion of a brewing module accordance with an embodiment.

### DETAILED DESCRIPTION

### Overview

Techniques are presented herein that enable espresso to be brewed using a modular espresso brewing system or a modular espresso maker. A modular espresso brewing system may efficiently heat liquid, e.g., water, using a heating element that is positioned between a liquid reservoir and ground coffee beans or espresso beans. The liquid is heated as the liquid passes through the heating element.

According to one embodiment, an apparatus includes a first module and a second module. The first module includes a first receptacle and a second receptacle, the first receptacle being configured to contain a liquid and a second receptacle being configured to contain coffee beans. The first module further includes a heating arrangement, the heating arrangement being at least partially positioned between the first receptacle and the second receptacle. The second module is configured to support the first module and to provide power to the heating arrangement when the first module is supported on the second module.

In another embodiment, a modular espresso brewing system includes a brewing module, the brewing module including a liquid chamber and a coffee bean receptacle, the liquid chamber being arranged to contain a liquid and the coffee bean receptacle being arranged to contain ground coffee beans. The brewing module includes a heating arrangement configured to heat the liquid, the heating arrangement being at least partially arranged between the liquid chamber and the coffee bean receptacle to heat the liquid as the liquid flows from the liquid chamber into the coffee bean receptacle. The modular espresso brewing system also includes a base module, the base module being configured to support the brewing module and to provide power to the heating arrangement when the brewing module is supported on the base module.

In yet another embodiment, an apparatus includes a liquid chamber arranged to contain a liquid, a bean reservoir arranged to contain coffee beans, and a pressure arrangement, the pressure arrangement including a piston, the piston being arranged to be extended through the liquid chamber to apply a pressure to push the liquid out of the liquid chamber and through the bean reservoir. The apparatus also includes a heating coil arranged between the liquid chamber and the bean reservoir, wherein the heating coil is configured to heat the liquid as the liquid is pushed from the liquid chamber through the bean reservoir by the piston, and a temperature sensor, the temperature sensor arranged between the heating coil and the bean reservoir, wherein the temperature sensor measures a temperature of the liquid.

### Example Embodiments

Espresso is a coffee beverage that is brewed or otherwise produced by forcing water through ground coffee beans under a relatively high pressure. Espresso makers or brewing systems are generally used to make espresso, e.g., to pull a shot of espresso. The espresso maker generally either heats a fluid such as water in a reservoir and forces the fluid through ground coffee beans at a relatively high pressure, or obtains a pre-heated fluid such as water that is then forced through ground coffee beans at a relatively high pressure.

Many espresso makers include pumps and valves which are used to provide water such that the water may be forced through ground coffee beans. The maintenance of pumps and valves, as well as other mechanisms, is often time-consuming and, hence, expensive. Further, pumps and valves may be difficult to repair. In addition, many espresso systems that are arranged to heat water operate inefficiently, as such espresso systems often heat substantially all water contained in a reservoir, i.e., more water is heated than may be necessary to brew a shot of espresso.

To brew espresso, measurements of coffee beans and fluid are made, a pressure under which the fluid is forced through the coffee beans is effectively set, coffee beans may be ground, etc. As such, espresso makers are often provided with mechanisms arranged to take measurements associated with coffee beans and a fluid, effectively setting a pressure under which fluid is forced through the coffee beans, and/or griding coffee beans. Further, accessories such as mechanisms which enable frothed or steamed fluid such as milk may be provided. Such mechanisms and accessories may also need maintenance. The maintenance and repair of such mechanisms and accessories may be difficult, particularly when the mechanisms and accessories are effectively integrated into the espresso makers.

By providing an espresso brewing system which does not utilize pumps and valves, the maintenance of the espresso brewing system may be relatively straightforward and, hence, the reliability of the espresso brewing system may be enhanced. Such an espresso brewing system may be configured to heat fluid, e.g., water, as the water is about to pass through ground coffee beans. As such, the heating of fluid may be more efficient as fluid which is not used to brew a shot is not heated.

Further, a modular brewing system enables mechanisms such as a coffee grinder, a steam wand, a pressure mechanism, and/or a measurement mechanisms such as a scale to be included as separate modules which are generally not effectively integrated into an espresso brewing module. As a result, the maintenance and repair of the such mechanisms and accessories may be accomplished efficiently as each mechanism and accessory may be maintained, and repaired, substantially separately.

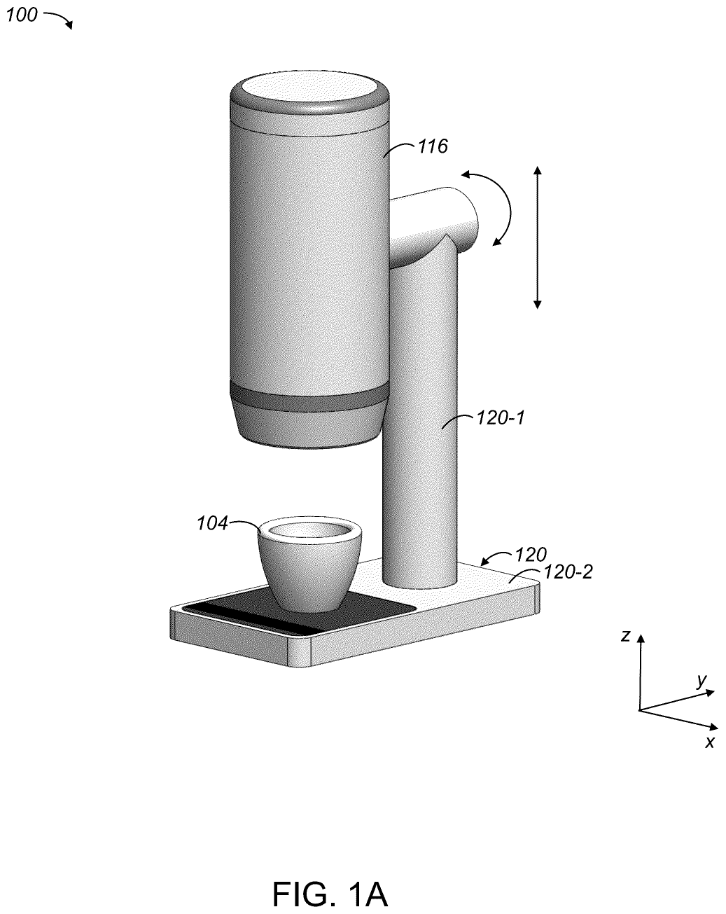

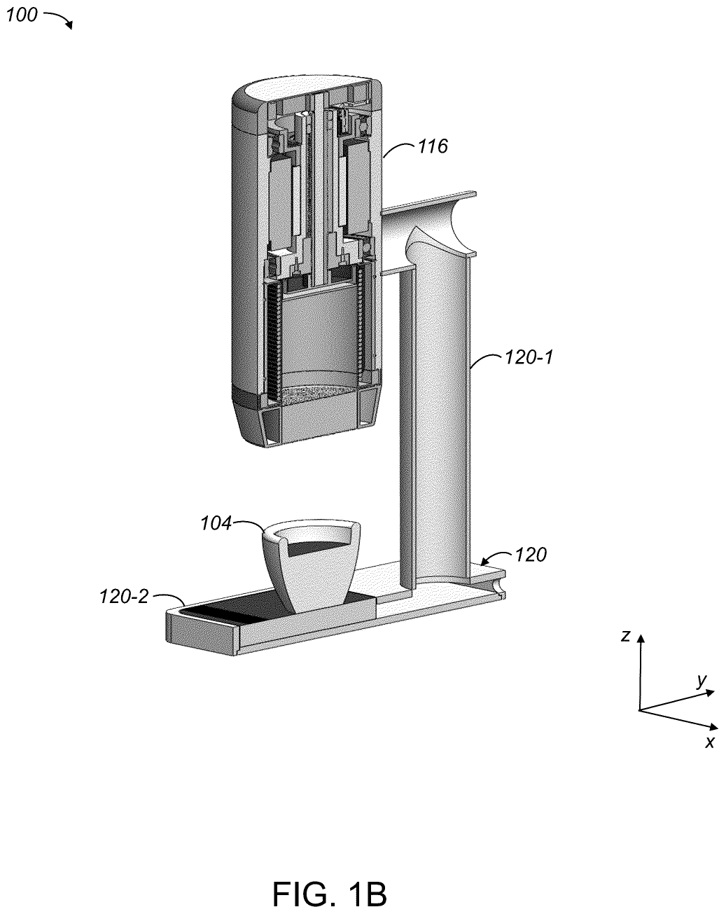

Referring initially to FIGS. 1A and 1B, modular espresso brewing system will be described in accordance with an embodiment. A modular espresso brewing system 100 includes a base module 120 and an espresso brewing module 116 that may be removably coupled. As shown, brewing module 116 or a brewing cylinder may be coupled to an arm 120-1 of base module 120. Arm 120-1 is arranged to rotate about a y-axis and to extend with respect to a z-axis. Arm 120-1 may be supported on a base unit 120-2 of base module 120. Base unit 120-2 may be arranged to support an espresso cup 104 substantially underneath brewing module 116 such that espresso may be dispensed into espresso cup 104. Arm 120-1 and base unit 120-2 may be substantially hollow such that components (not shown), e.g., printed circuit boards (PCBs) and/or cables such as power cables, may effectively be housed within arm 120-1 and base unit 120-2.

Arm 120-1 may extend or otherwise translate along a z-axis to effectively raise and to lower brewing module 116 above cup 104. That is, arm 120-1 may extend vertically. Arm 120-1 may be configured to effectively couple to brewing module 116 to along rotation of brewing module 116 about a y-axis, or horizontally. The coupling of brewing module 116 to arm 120-1 may be accomplished, in one embodiment, when arm 120-1 includes hollow flanged shaft that attaches to a flanged end (not shown) mounted on or integral to an outer cylindrical wall of brewing module 116. Part of such a hollow flanged shaft may passes through one or more bearings (not shown) which allow rotation of brewing module 116 that are mounted inside a vertical tube (not shown) that is relatively rigidly attached to arm 120-1. On the end opposite the flange of the hollow flanged shaft, a nut may holds the hollow shaft in place.

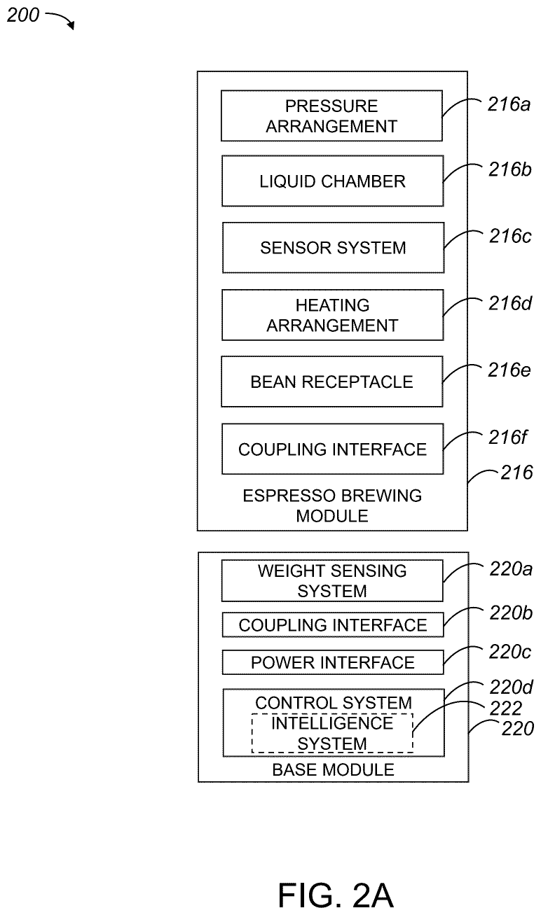

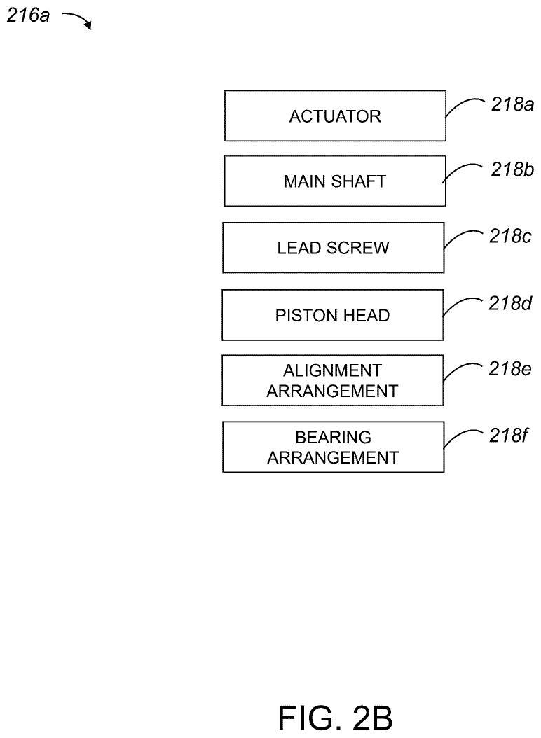

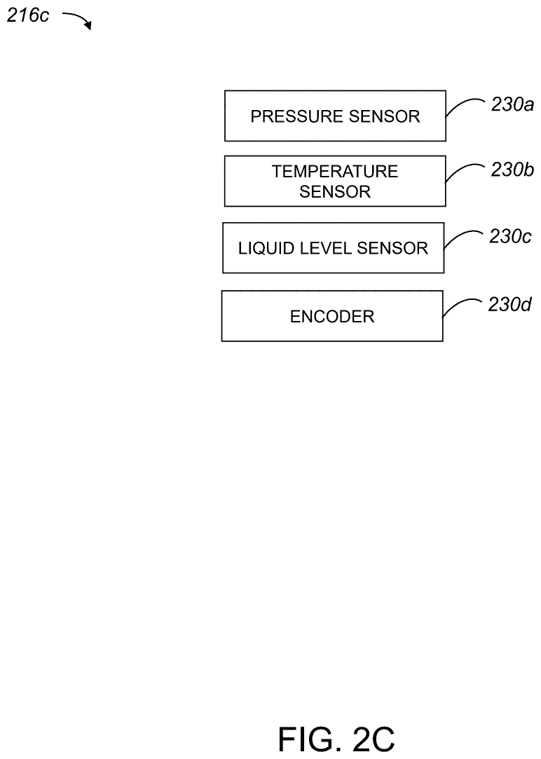

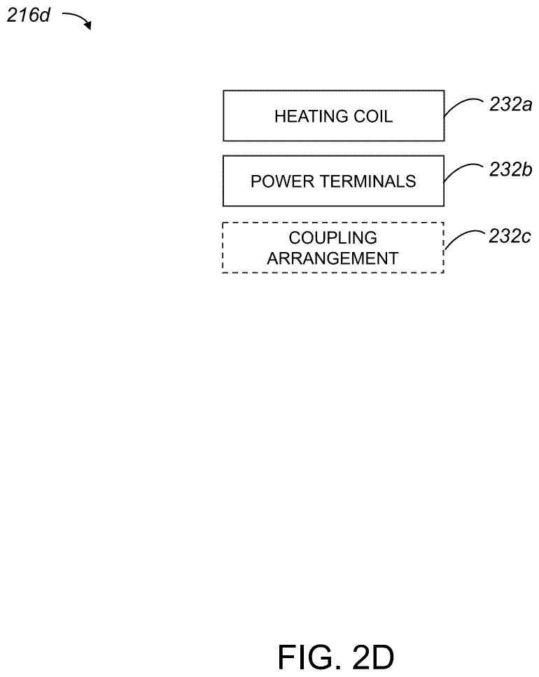

Base unit 120-2 may effectively house or otherwise contain PCBs and other boards (not shown) which facilitate the operation of brewing module 116. For example, as will be discussed below with respect to FIG. 2, base unit 120-2 may include a control system and a sensing system which enables espresso brewing parameters to be set and effectively implemented to brew shots or servings of espresso. It should be appreciated that base unit 120-2 may include control mechanisms, as for example knobs and switches, which are not shown for case of illustration. For instance, base unit 120-2 may include a power switch (not shown) and a knob (not shown) which enable a pressure at which espresso may be brewed to be selected.

FIG. 2A is a block diagram representation of a modular espresso brewing system in accordance with an embodiment. A modular espresso brewing system 200 may include an espresso brewing module 216 and a base module 220. Espresso brewing module 216 may include a pressure arrangement 216a, a liquid chamber 216b, a sensor system 216c, a heating arrangement 216d, a bean receptacle 216e, and a coupling interface 216f. Base module may include a weight sensing system 220a, a coupling interface 220b, a power interface 220c, and a control system 220d.

Pressure arrangement 216a may be arranged to effectively apply pressure to force a liquid such as water through brewing module 216 when a shot of espresso is to be brewed. One embodiment of pressure arrangement 216a will be discussed below with respect to FIG. 2B. Liquid chamber 216b may be a reservoir or receptacle that is configured to obtain and to hold a liquid that is to be used to brew a shot of espresso. Sensor system 216c includes sensors which may be used to facilitate the brewing of a shot of espresso. One embodiment of sensor system 216c will be described below with reference to FIG. 2C. Heating arrangement 216d is configured to heat liquid contained in liquid chamber 216b, and may be substantially integrated into walls of brewing module 216, and/or positioned to heat liquid as the liquid flows out of liquid chamber 216b. Heating arrangement 216d will be described in more detail below with respect to FIG. 2D. Bean receptacle 216e may be part of a portafilter mechanism which is configured to hold ground coffee that is to be used to brew a shot of espresso. In one embodiment, bean receptacle 216e may hold a “puck” of ground coffee, and may include a puck screen positioned over the puck. Coupling interface 216f is configured to enable brewing module 216 to be coupled to base module 220. Coupling interface 216f may include, but is not limited to including, mechanical coupling interfaces, electrical coupling interfaces, and interfaces which enable data to be provided to and obtained from brewing module 216 by base module 220.

Weight sensing system 220a includes one or more weight sensors which may be calibrated such that a weight of ground coffee beans and/or a weight of liquid contained in brewing module 216 may be measured or otherwise determined. Coupling interface 220b may be arranged to physically engage coupling interface 216f to substantially secure brewing module 216 to base module 220. Coupling interface 220b may generally also be arranged to enable data signals to be provided to and obtained through coupling interface 216f, and to enable power obtained via power interface 220c to be provided through coupling interface 220b to coupling interface 216f. In one embodiment, coupling interface 220b includes an arm such as arm 120-1 of FIGS. 1A and 1B which enables brewing module to be movably coupled to base module 220. Power interface 220c is configured to obtain electrical power from a power source and to provide electrical power within brewing system 200. The power source may be an external power source, and power interface 220c may be arranged to plug into the external power source. In one embodiment, power interface 220c may include a battery. Control system 220d may generally include devices and/or mechanisms which enable the brewing of espresso using brewing system 200 to be controlled, as for example by setting brewing parameters related to, but not limited to being related to, an amount of coffee beans, an amount of liquid, a pressure of the liquid, a temperature of the liquid, etc. In one embodiment, control system 220d may include an optional intelligence system 222 which enables historical brewing parameters to be imported for use, enables current brewing parameters to be stored for future use, enables current brewing parameters to be shared to public databases and/or social media platforms, etc.

FIG. 2B is a block diagram representation of pressure arrangement 216a of FIG. 2A in accordance with an embodiment. Pressure arrangement 216a may generally enable liquid contained in a reservoir or chamber such as liquid chamber 216b of FIG. 2A to be subjected to pressure. In one embodiment, force may be exerted on the liquid to effectively push the liquid in a downwards direction. Pressure arrangement 216a includes an actuator 218a, a main shaft 218b, a lead screw 218c, a piston head 218d, an alignment arrangement 218e, and a bearing arrangement 218f.

Actuator 218a, which may be an electric motor, is configured to cause main shaft 218b to rotate about a vertical axis. Actuator 218a may be connected to a gear box (not shown), in one embodiment, which is configured to increase a thrust associated with main shaft 218b. Such a gear box (not shown) may be a planetary gear box of a strain wave gear box. As main shaft 218b rotates, lead screw 218c may be driven linearly to move piston head 218d upwards and/or downwards with respect to the vertical access. Alignment arrangement 218e may generally include one or more mechanisms including, but not limited to including, splines, flexures, nuts, etc. which may guide or effectively constrain the movement of main shaft 218b, lead screw 218c, and/or piston head 218d. Bearing arrangement 218f may include one or more bearings which facilitate the movement of main shaft 218b.

FIG. 2C is a block diagram representation of sensor system 216c of FIG. 2A in accordance with an embodiment. Sensor system 216c includes a pressure sensor 230a, a temperature sensor 230b, a liquid level sensor 230c, and an encoder 230d. Pressure sensor 230a is configured to effectively measure the pressure of liquid such as water when the liquid contained in liquid chamber 216b of FIG. 2A is subjected to pressure applied by pressure arrangement 216a of FIGS. 2A and 2B. Pressure sensor 230a may be configured, in one embodiment, as a strain gauge on a mesh or a screen positioned on a coffee puck or tamped ground coffee contained in bean receptacle 216e of FIG. 2A, e.g., a strain gauge on a puck screen positioned over, or otherwise substantially adjacent to, a coffee puck. Temperature sensor 230b may be arranged to measure the temperature of liquid used to brew espresso from the coffee puck or tamped ground coffee. Temperature sensor 230b may be, but is not limited to being, a thermocouple oriented near heating arrangement 216d of FIG. 2A, e.g., a thermocouple oriented substantially between a heating arrangement and a puck screen positioned on the coffee puck or tamped ground coffee. Liquid level sensor 230c may be any suitable sensor positioned in liquid chamber 216b of FIG. 2A that may detect a level of liquid contained in liquid chamber 216b, and/or may detect an amount of liquid dispensed to brew espresso from a coffee puck or tamped ground coffee. Encoder 230d, which may be a rotary encoder, may be provided on an actuator such as actuator 218a of FIGS. 2A and 2B, to provide an ability to measure and to utilize closed-loop control of pressure arrangement 216a such that a flow rate of liquid as the liquid flows over coffee may be determined.

FIG. 2D is a block diagram representation of heating arrangement 216d of FIG. 2A in accordance with an embodiment. Heating arrangement 216d is configured to heat liquid that is to be substantially forced through a coffee puck or tamped ground coffee contained in bean receptacle 216e of FIG. 2A. Heating arrangement 216d may include a heating coil 232a, one or more power terminals 232b and an optional coupling arrangement 232c.

Heating coil 232a emanates heat that heats liquid contained in liquid chamber 216b of FIG. 2A. Heating coil 232a may essentially be a coiled tube, and may be formed from a pliable or flexible material including, but not limited to including, metal which is a shape memory alloy, metal that is a super-elasticity alloy, silicone rubber, metal foil, and/or polyimide. For example, heating coil 232a may be formed from nickel titanium or nitinol, a nitinol alloy, and/or a similar material that has shape memory and super-elasticity features. It should be appreciated that heating coil 232a may be substantially electrically insulated using a dielectric material including, but not limited to including, magnesium oxide, boron nitride, and/or boron silicate glass. Heating coil 232a may be arranged in any suitable orientation with respect to liquid chamber 216b of FIG. 2A. For example, when liquid chamber 216b of FIG. 2A has a substantially cylindrical shape, heating coil 232a may be substantially wrapped around an interior and/or an exterior surface of liquid chamber 216b. In one embodiment, heating coil 232a may be arranged substantially at a bottom of liquid chamber 216b of FIG. 2A such that liquid is heated by heating coil 232a as liquid is effectively pushed through a coffee puck or tamped coffee grounds contained in bean receptacle 216c of FIG. 2A to brew a shot of espresso.

One or more power terminals 232b may be arranged to provide power to heating coil 232a. The power may be obtained through coupling interface 216f of FIG. 2A. Optional coupling arrangement 232c may be configured to enable heating arrangement 216d to effectively be coupled to sides of or surfaces associated with liquid chamber 216b of FIG. 2A

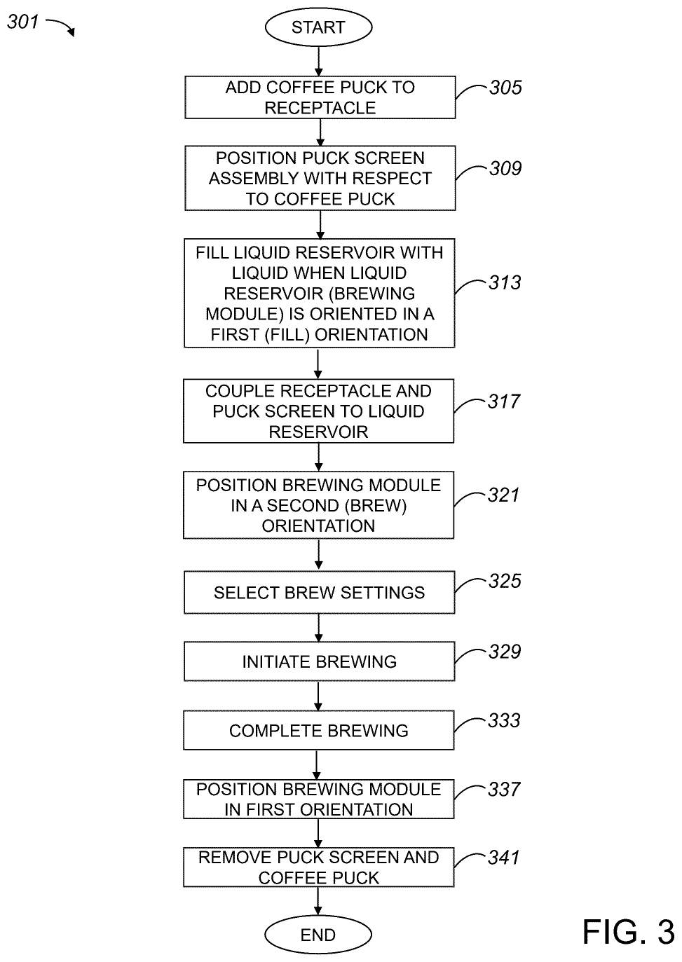

With reference to FIG. 3, a method of utilizing a modular espresso brewing system in accordance with an embodiment. A method 301 of utilizing or operating a modular espresso brewing system begins at a step 305 in which a coffee puck is added to a receptacle of the brewing system, e.g., bean receptacle 216e of FIG. 2A. Adding a coffee puck to a receptacle may generally include spooning or pouring ground coffee beans into the receptacle, and tamping the ground coffee beans, as for example using a tamping tool, to effectively create a puck The amount of coffee included in a coffee puck may vary depending up factors including, but not limited to including, the strength of an espresso shot that is desired and/or the weight of the coffee.

Once the coffee puck is provided to the receptacle, a puck screen assembly may be positioned with respect to the coffee puck in a step 309. The puck screen assembly may include a mesh, a substantially solid perimeter around the mesh, and one or more sensors, as for example a pressure sensor. Positioning the puck screen assembly may include substantially coupling the puck screen assembly to the receptacle such that the puck screen assembly is effectively positioned over the coffee puck.

In a step 313, a brew or liquid reservoir such as liquid reservoir or chamber 216b of FIG. 2A is at least partially filled with liquid while a brewing module of the brewing system is oriented in a first orientation, or a “fill” orientation. The amount of liquid provided may vary depending upon factors including, but not limited to including, the size of an espresso shot desired and/or the strength of the espresso shot desired. When the brewing module is oriented in a first orientation, the brewing module may either be separate from a base module of the brewing system or coupled to an arm of the base module.

After the liquid reservoir is at least partially filled, the receptacle and the puck screen are coupled to the liquid reservoir in a step 317. The receptacle and the puck screen, as for example a portafilter, may be coupled to the liquid reservoir using any suitable method and/or any suitable mechanism. A locking system such as a cam lock with lever handles may effectively clamp the portafilter to the liquid reservoir. The locking system may incorporate an O-ring or similar feature that provides a seal. For example, the locking system may incorporate a clamping collar, a pneumatic quick release, magnets, and/or a system which utilizes fastening features such as threads and screws. Magnets may be arranged to be mechanically switched on and off such that a portafilter may effectively be locked and unlocked from a liquid reservoir. An O-ring may be deformable when in a rest state, and may be arranged to be squeezed to deform when the locking system is engaged. In one embodiment, a heating coil may be included in the portafilter and, as such, coupling the receptacle and the puck screen to the liquid reservoir may also include positioning the heating coil with respect to the liquid reservoir.

The brewing module is positioned in a second orientation, e.g., a “brew” orientation, in a step 321. The brew orientation may be approximately one hundred and eighty degrees from a fill orientation. Positioning the brewing module in a second orientation may include coupling or otherwise attaching the brewing module to an arm of a base module. It should be appreciated, however, that if the brewing module is already attached or coupled to the arm of the base module, positioning the brewing module in the second orientation may involve rotation the arm of the base module.

Once the brewing module is positioned in the second orientation, brew settings may be selected in a step 325. Selecting brew settings may include programming or otherwise adjusting settings including, but not limited to including, a desired temperature for an espresso shot, a flow rate at which the espresso shot is to be pulled, and/or a pressure at which the espresso shot is to be pulled. The brew settings may be selected using hardware and/or software logic associated with the brewing system. For example, mechanical knobs and/or switches may be used to select settings. Alternatively, a user interface that includes a computing device, e.g., a computing device included on the brewing system or a computing device that may communicate over a network with the brewing system, may be used to effectively program settings into the brewing system.

After the brew settings are selected, brewing is initiated in a step 329. Initiating brewing may include, but is not limited to including, causing power to be provided to the brew module such that an actuator causes a piston arrangement to apply pressure to the liquid, causing power to be provided to the brew module such that a heating element heats the liquid, and causing the liquid to flow through the coffee puck.

In a step 333, brewing is completed. That is, an espresso shot is pulled. Brewing may be completed when substantially all liquid contained in the liquid reservoir has passed through the coffee puck.

Upon completion of brewing, the brewing module is positioned in a first orientation in a step 337. Positioning the brewing module in the first orientation may include rotating the brewing module on an arm of a base module approximately one hundred and eighty degrees.

The puck screen and the coffee puck are removed in a step 341. For example, a portafilter that includes the used coffee puck and the puck screen is effectively decoupled from the rest of the brewing module such that the used coffee puck may be disposed of. Once the puck screen and the coffee puck are removed, the method of utilizing or operating a modular espresso brewing system is completed.

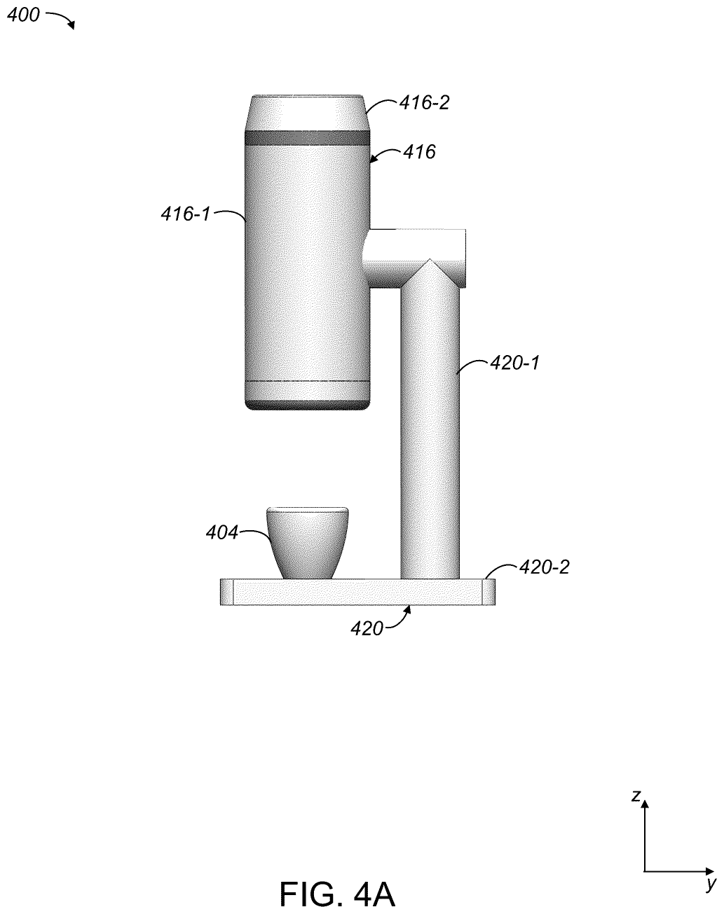

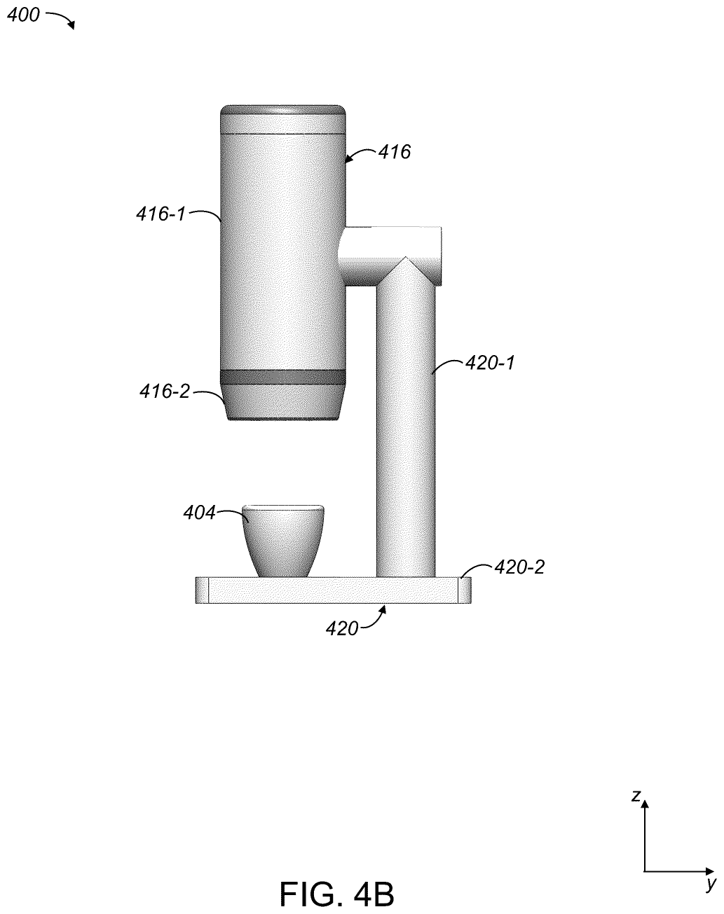

Referring next to FIGS. 4A and 4B, a first orientation and a second orientation of a brewing system will be described in accordance with an embodiment. A brewing system 400 includes a brewing module 416 and a base module 420.

Brewing module 416 includes a first part 416-1 and a second part 416-2. First part 416-1 generally includes a liquid reservoir or chamber arranged to be filled to contain a liquid such as water, and second part 416-2 includes a bean receptacle. In one embodiment, second part 416-2 is an apparatus that is configured to effectively hold ground coffee beans when brewing system 400 brews espresso, e.g., second part 416-2 may be a portafilter. First part 416-1 and second part 416-2 may generally be coupled or otherwise assembled together to from base module 416, as for example after liquid is provided in first part 416-1 and a coffee puck is provided in second part 416-2.

Base module 420 includes an arm 420-1 and a base unit 420-2. Arm 420-1 is configured to engage brewing module 416, and enables brewing module 416 to move upwards and downwards with respect to a z-axis, and to rotate or pivot about a y-axis. Base until 420-2 may support a cup 404 into which espresso brewed in brewing module 416 may be dispensed.

As shown in FIG. 4A, brewing system 400 which includes a brewing module 416 is in a first orientation, or a fill orientation, with first part 416-1 and second part 416-2 assembled together. It should be appreciated that while first part 416-1 is being filled with liquid, second part 416-2 is not assembled to first part 416-1. In some situations, first part 416-1 may be engaged with arm 420-1 during a filling process. In other situations, brewing module 416 is not engage with arm 420-1 until after first part 416-1 and second part 416-2 are assembled together. When brewing module 416 is in the first orientation, second part 416-2 is substantially above first part 416-1 relative to the z-axis.

Brewing system 400 may be positioned in a second orientation, or a brew orientation, when espresso is to be brewed, as shown in FIG. 4B. When brewing module 416 is in the second orientation, second part 416-2 is substantially below first part 416-1 relative to the z-axis. The second orientation enables liquid contained in first part 416-1 to effectively be forced through a coffee puck contained in second part 416-2 to expel or dispense coffee into cup 404.

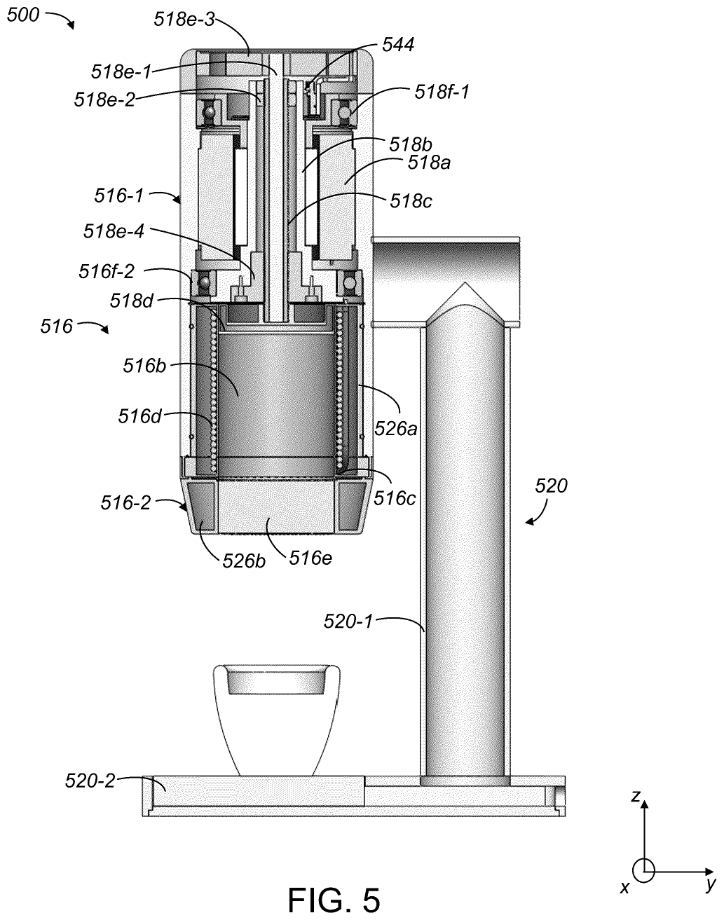

FIG. 5 is a diagrammatic cross-sectional side-view representation of a modular espresso brewing system accordance with an embodiment. A modular espresso brewing system 500 includes a brewing module 516 that includes a first part 516-1 and a second part 516-2, and a base module 520 that includes an arm 520-1 and a base unit 520-2. Brewing module 516 is shown in a second, or brew, orientation.

Arm 520-1 of base module 520 includes a vertical column and a horizontal structure, and is configured to engage brewing module 516 such that brewing module 516 may effectively be rotated between a first orientation and a second orientation. Arm 520-1 may be hollow and may provide connections, as for example cables, which enable electrical signals and/or data to be provided to brewing module 516 from base module 520, and enable data to be provided from brewing module 516 to base module 520.

Base unit 520-2 may include a weight sensing system that includes a scale to measure weight and/or mass associated with brewing system 500, and may contain printed circuit boards (PCBs) and cables associated with brewing system 500. The scale may be calibrated to provide the weight of a coffee puck, the weight of liquid, and/or the weight of a shot of espresso.

First part 516-1 includes a double-walled vacuum cylinder 526a which is arranged to provide insulation to first part 516-1. An actuator 518a, which may be an electric motor, is arranged to drive a main shaft 518b, as for example by causing main shaft 518b to rotate. Main shaft 518b may be connected to a nut arrangement 518e-2 which includes an acme nut, and substantially fit within bearings 518f-1 and bearings 518f-2. Lead screw 518c may be driven substantially linearly by rotating nut arrangement 518c-2 or, more specifically, a nut associated with nut arrangement 518e-2 by rotating the nut to move a piston head 518d upwards and downwards with respect to a z-axis. A spline 518c-1 may be arranged to substantially prevent lead screw 518c from spinning. Nut arrangement 518e-2 includes an acme nut and a jam nut which is oriented on lead screw 518c, which may be an acme screw. The nut and jam nut may generally enable lead screw 518c to remain substantially centered within a bore of main shaft 518b. A flexure 518e-3 is arranged to effectively hold spline 518e-1 to essentially prevent rotation while allowing for translation movement along an x-axis and a y-axis such that jamming inside lead screw 518c may be reduced.

An encoding arrangement 544 is positioned on an end of main shaft 518b to substantially enable closed-loop control of a speed associated with actuator 518a and a vertical position, or a position relative to a z-axis, of a piston head 518d. Piston head 518d may be formed from a double-walled vacuum cylinder, and may effectively define an edge or surface of a liquid chamber 516b. For example, when brewing module 516 is in a first orientation or a fill orientation, a surface of piston head 518d may essentially define a bottom of chamber 516b. An overall piston arrangement that includes main shaft 518b and piston head 518d is configured to retract in a downward vertical direction when brewing module 516 is in a first orientation to allow a relatively precise volume of liquid inside liquid chamber 516b to effectively be measured.

Liquid, as for example water, in reservoir or chamber 516b may be heated by a heating arrangement 516d that is effectively located inside the walls of double-walled vacuum cylinder 526a. It should be appreciated that heating arrangement 516d may instead be located substantially at a surface defined between chamber 516b and a bean receptacle 516e, e.g., at least partially in contact with a puck screen (not shown). Heating arrangement 516d is arranged to heat liquid contained in chamber 516b until the liquid reaches a desired temperature, and then to maintain the liquid at the desired temperature. That is, heating arrangement 516d is configured to cause liquid to reach a desired temperature, and once the desired temperature is achieved, heating arrangement 516d is configured to maintain the liquid at the desired temperature.

A sensor arrangement 516c may include, but is not limited to including, temperature and pressure sensors which are configured to measure a temperature and a pressure, respectively, of liquid contained in chamber 516b. The measurements of temperature and pressure may be used for closed-loop thermal control with heating arrangement 516d. It should be appreciated that while temperature and pressure are described as being measured by sensors included in sensor arrangement 516c, sensor arrangement 516c may generally include sensors to measure temperature, pressure, time, and/or flow rate. In addition, measurements of temperature, pressure, time, and/or flow rate may be used for closed-loop thermal control.

Second part 516-2, which may be a portafilter, includes bean receptacle 516e that is arranged to contain a coffee puck. Second part 516-2 includes a double-walled vacuum cylinder 526b, although it should be understood that second part 516-2 is not limited to including double-walled vacuum cylinder 526b, e.g., second part 516-2 may include a double-walled cylinder that is not under vacuum.

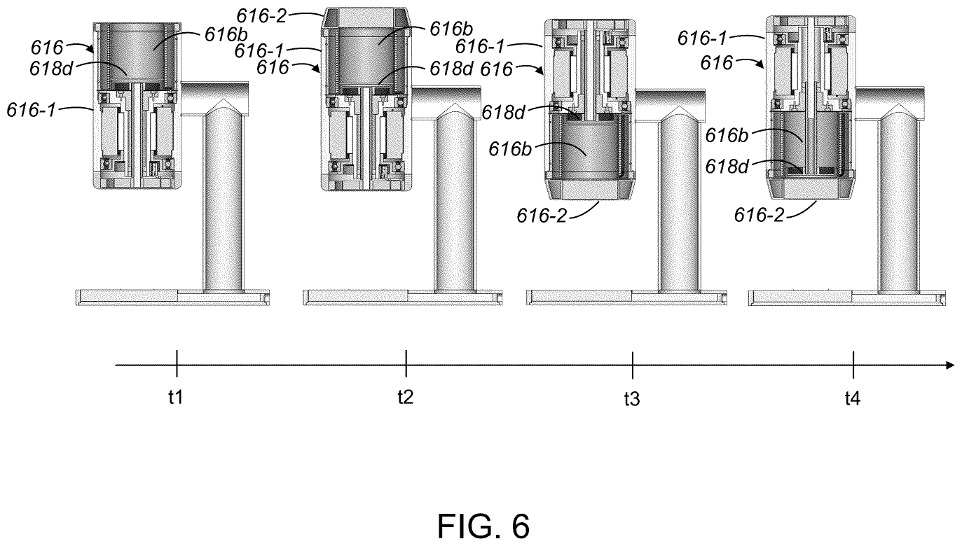

With reference to FIG. 6, the steps associated with using a modular espresso brewing system will be described with reference to a timeline in accordance with an embodiment. At a time t1, a first part 616-1 of a brewing module 616 is oriented in a first orientation such that a piston head 618d is substantially retracted or otherwise in a position in which first part 616-1 may be filled with a largest volume of liquid. When oriented in a first orientation and when essentially uncovered or open, first part 616-1 is effectively ready to receive or to otherwise obtain liquid. Piston head 618d is part of a piston arrangement, and the piston arrangement retracts piston head 618d to a position that corresponds to a desired amount of liquid that is to fill a brew or liquid chamber 616b. It should be appreciated that brewing module 616 may be locked into the first orientation using a mechanical lock or similar mechanism.

At a time t2, after a desired amount of liquid is added to chamber 616b, a second part 616-2 of brewing module 616 is coupled to first part 616-1. That is, second part 616-2 may be locked to first part 616-1 after second part 616-2 is positioned with respect to first part 616-1. Second part 616-2 may be a portafilter that contains a coffee puck. As shown, second part 616-2 is positioned over chamber 616b.

At a time t3, brewing module 616 is oriented in a second, or brew, orientation such that second part 616-2 is positioned substantially under chamber 616b. The second orientation may be approximately one hundred and eighty degrees from the first orientation. That is, brewing module 616 may be rotated by approximately one hundred and eighty degrees by a user such that second part 616-2 moves from being on top of brewing module 616 to being on a bottom of brewing module 616. It should be appreciated that brewing module 616 may be locked into the second orientation using a mechanical lock or similar mechanism. Piston head 618d is still in a retracted position at time t3.

At a time t4, after the liquid contained in chamber 616b is heated to a desired brew temperature, piston head 618d is moved to an extended position such that heated liquid contained in chamber 616b is forced through second part 616-2 as espresso is brewed. In other words, piston head 618d may move downwards to effectively push a column of liquid through coffee grounds or a coffee puck contained in second part 616-2 to pull or brew a shot of espresso. The espresso may be captured in a cup or other vessel (not shown).

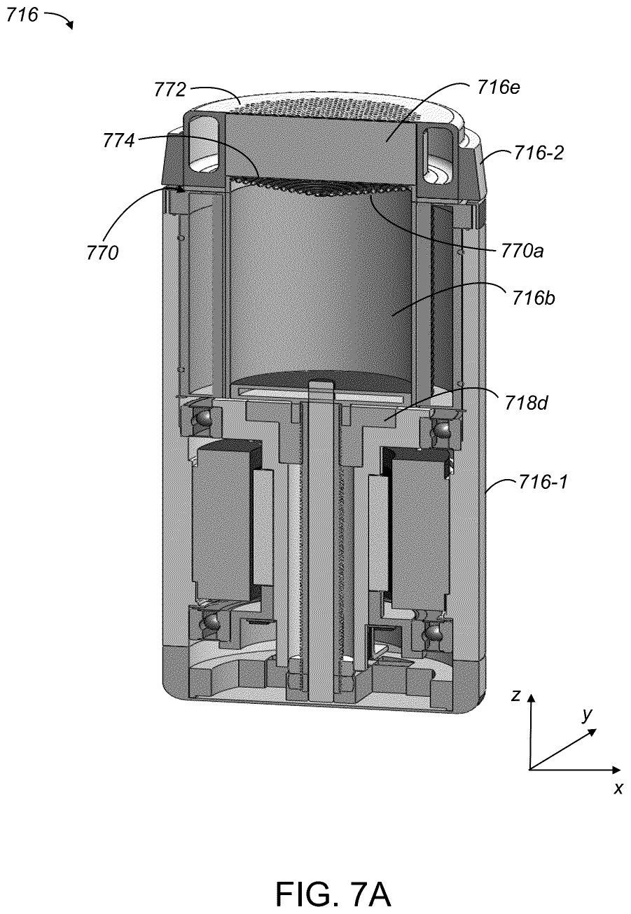

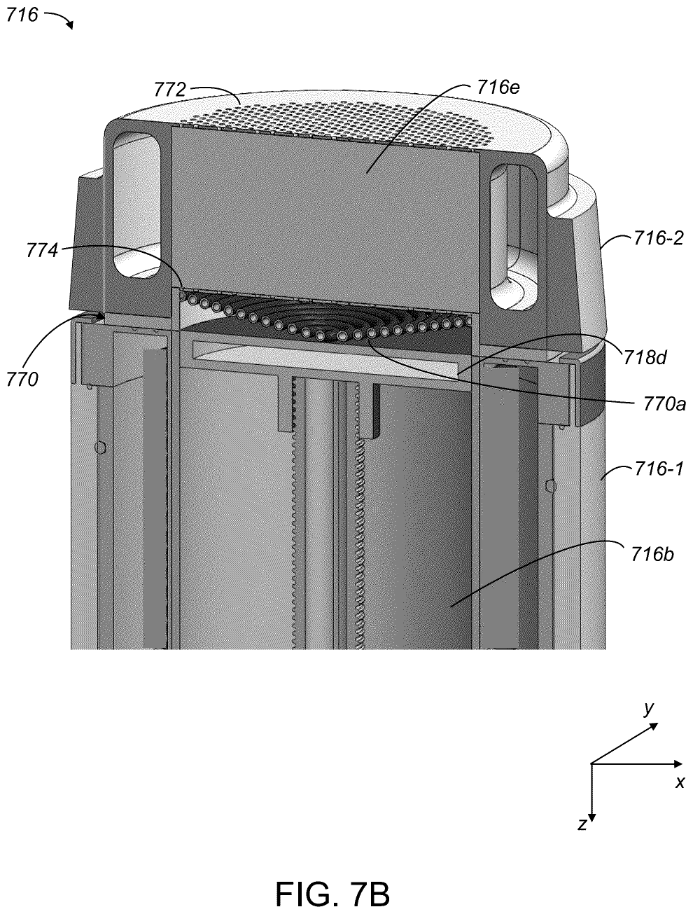

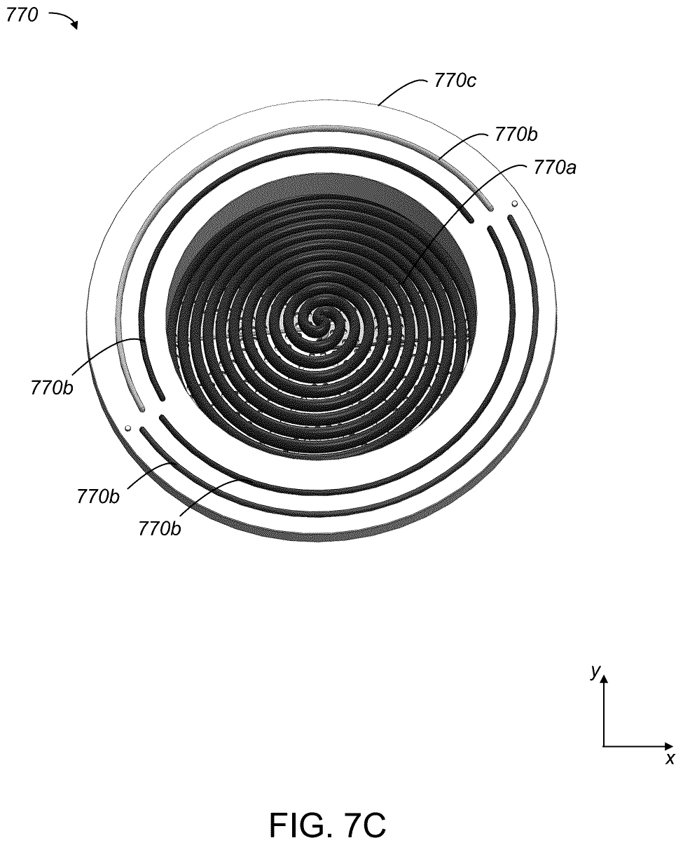

A heating arrangement that is arranged to heat liquid contained in a chamber of a brewing module may be positioned substantially within the chamber. That is, a heating arrangement may be located in a chamber such that liquid comes into substantially direct contact with the heating arrangement. In one embodiment, a heating arrangement may be positioned in a brew or liquid chamber such that at least a part of the heating arrangement may be in contact with a portafilter arrangement. FIG. 7A is a diagrammatic cross-sectional representation of an espresso brewing module which includes a portafilter arrangement with a heating element in accordance with an embodiment. A brewing module 716 includes a first portion or a chamber portion 716-1 and a second part or a portafilter portion 716-2. Chamber portion 716-1 includes a brew or liquid chamber 716b which may hold a liquid such as water. A piston head 718d is included in chamber portion 716-1 and is, as shown, in a retracted position when brewing module 716 is in a first or fill orientation. Portafilter portion 716-2 includes coffee puck 716e held in a coffee receptacle, a component 772, and a puck screen 774. Puck screen 774 may be a screen or a mesh, e.g., a screen that includes an array of circular openings. Component 772 may be a screen or a mesh that is arranged over coffee puck 716e when brewing module 716 is in a first or fill orientation. Component 772 may effectively be a bottommost layer of material, as for example metal, in portafilter portion 716-2 when brewing module 716 is oriented to pull a shot of espresso. In one embodiment, puck screen 774 may include one or more substantially integrated sensors such a temperature sensors.

A heating arrangement 770 may include a heating coil 770a that is oriented at least partially within chamber 716b such that liquid may be heated as liquid flows out of chamber 716b and through coffee puck 716e when brewing module 716 is subsequently oriented in a second or brew orientation. Heating coil 770a may be shaped as a conical spiral, and may be formed by any suitable flexible material. When heating coil 770a is formed from a flexible material, heating coil 770a may flex or deform or deform when force is applied to heating coil 770a, e.g., when force is applied by piston head 718d when piston head 718d pushes liquid out of chamber 716b. A conical spiral, in one embodiment, may be a Fermat spiral in which a center of the Fermat spiral has an apex that is displaced with respect to the outside of the Fermat spiral such that a cross-section of heating coil 770a relative to a xz-plane has a substantially triangular profile or a profile that is shaped as approximately an isosceles trapezoid. It should be appreciated that heating coil 770a may be planar, e.g., heating coil 770a may be a Fermat spiral that is substantially flat and does not protrude along a z-axis to effectively form a triangular or trapezoidal cross-sectional shape.

FIG. 7B is a diagrammatic cross-sectional representation of a portion of espresso brewing module 716 as shown when piston head 718d is oriented against heating coil 770a, as for example after piston head 718d has pushed liquid out of chamber 716b. Piston head 718d is shown in an extended position, and brewing module 716 is in a second or brew orientation.

As shown in FIG. 7C, heating arrangement 770 or a heating coil assembly of FIGS. 7A and 7B, in accordance with an embodiment. Heating coil 770a may be shaped as a Fermat spiral coil, or any other suitable coil shape, and may be positioned or secured within a frame or bezel 770c. Bezel 770c enables heating arrangement 770 to be held within brewing module 716 of FIGS. 7A and 7B. Power connections 770b may be substantially embedded in bezel 770c to provide power to heating coil 770a by interfacing with or otherwise connecting to corresponding connections on brewing module 716 of FIGS. 7A and 7B. In one embodiment, power connections 770b may provide power to a pressure sensor and/or a temperature sensor associated with brewing module 716 of FIGS. 7A and 7B.

The heating profile of heating coil 770a may be configured such that the amount of heat generated throughout heating coil 770a may vary. For example, an inner section of heating coil 770a may be arranged to be heated more quickly to a desired temperature than an outer section or diameter of heating coil 770a. The relative cross-sectional diameter of the tube or wire used to form heating coil 770a may vary to effectively adjust the heating profile. For example, the cross-sectional diameter of heating coil 770a may vary such that a portion of heating coil 770a with a smaller cross-sectional diameter may heat to a desired temperature in a shorter time than a portion of heating coil 770a with a larger cross-sectional diameter. In one embodiment, a center of heating coil 770a may be thinner than an edge of heating coil 770a such that the center of heating coil 770a may becomes hotter when a particular current is provided than the edge of heating coil 770a.

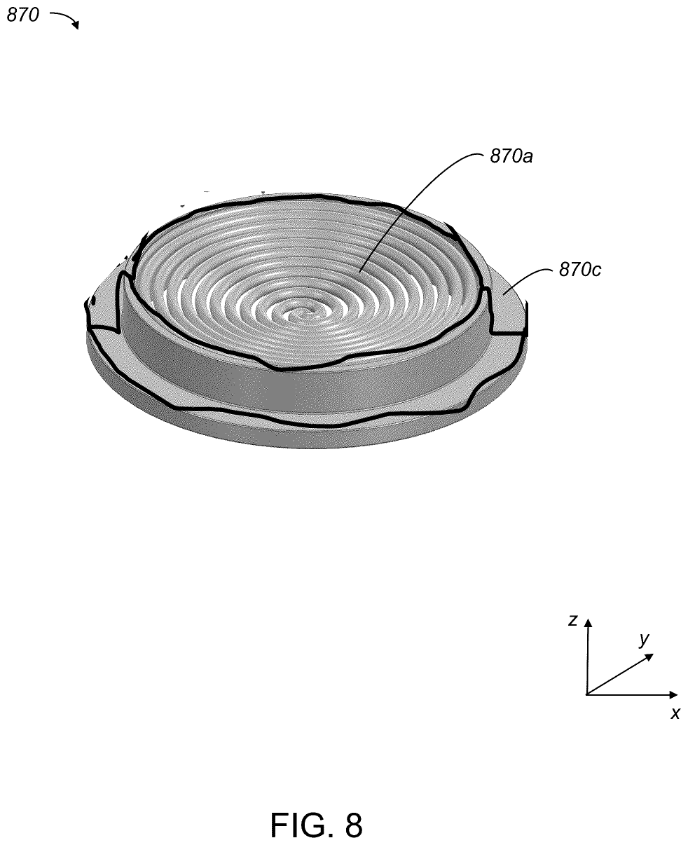

FIG. 8 is a diagrammatic perspective representation of a heating coil assembly with a conically-shaped heating coil in accordance with an embodiment. A heating coil assembly 870 includes a heating coil 870a that is coupled to a frame or bezel 870c. Heating coil 870a, which may be configured in the shape of a Fermat spiral, may be sized to facilitate the compression of heating coil 870a relative to a z-axis. When heating coil 870a is compressed, an apex of the conical configuration may effectively be forced in a direction along the z-axis such that heating coil 870a may effectively be flattened.

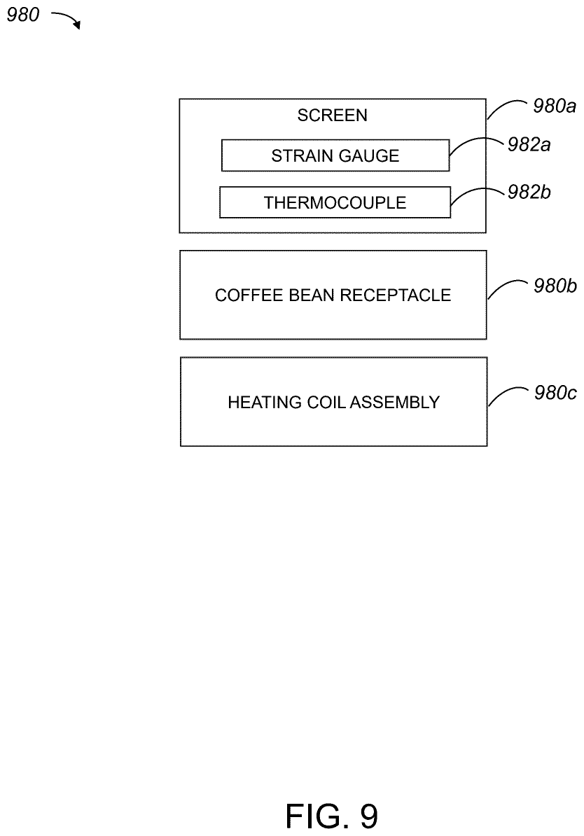

A portafilter arrangement or part of a brewing module that is arranged to contain coffee grounds, e.g., as a coffee puck, may be arranged, in one embodiment, to effectively include a heating coil assembly. FIG. 9 is a block diagram representation of a portafilter arrangement in accordance with an embodiment. A portafilter arrangement 980 includes a screen 980a or a puck screen, a coffee bean receptacle 980b, and a heating coil assembly 980c.

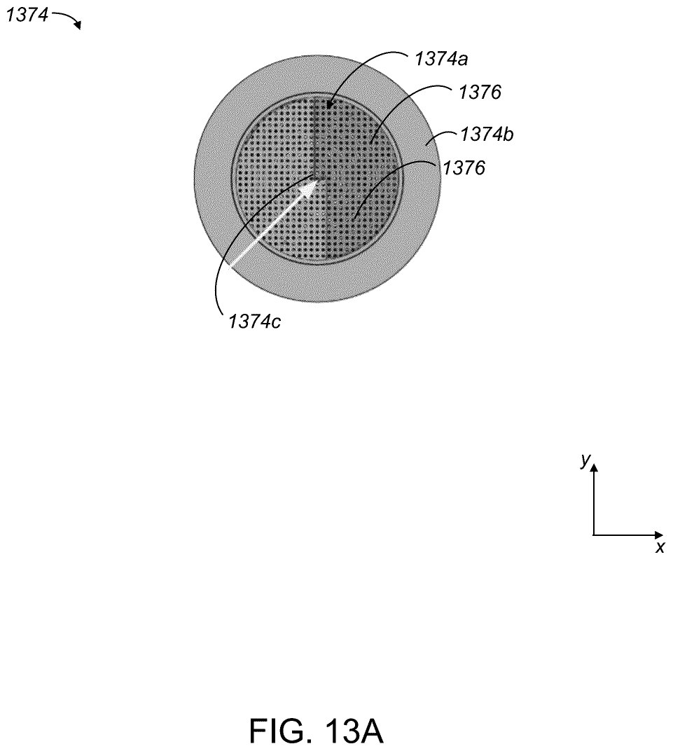

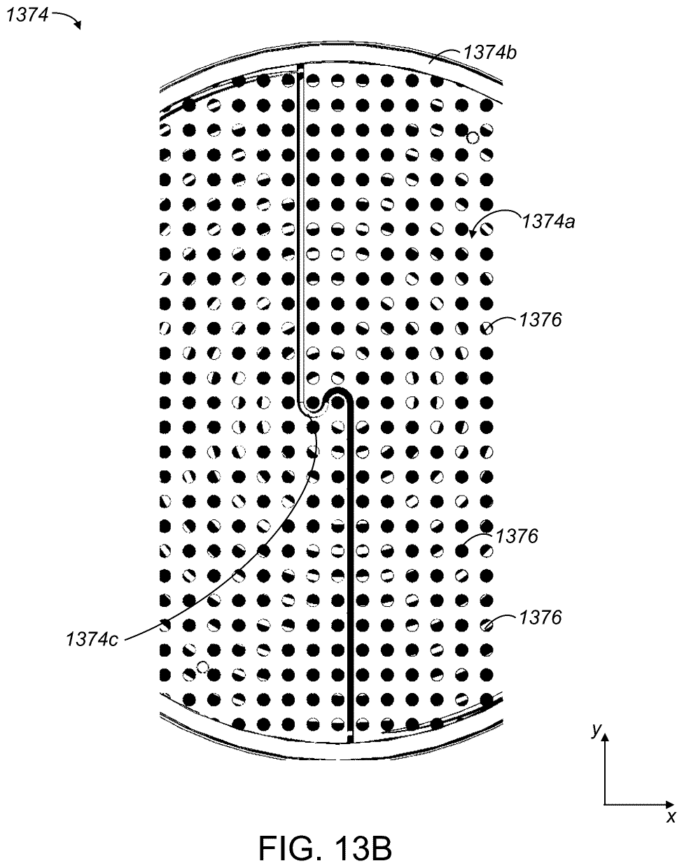

Screen 980a may include a bezel and a mesh or screen portion which may be configured, in one embodiment, as a surface in which an array of openings are defined. One embodiment of screen 980a will be discussed below with reference to FIGS. 13A and 13B. Screen 980a may include a strain gauge 982a and a thermocouple 982b. Strain gauge 982a may be configured to measure or otherwise determine the pressure of liquid as the liquid passes through screen 980a. Thermocouple 982b may be configured to measure or otherwise determine the temperature of liquid as the liquid passes through screen 980a. Strain gauge 982a and/or thermocouple 982b may be integrated into screen 980a. It should be understood that although strain gauge 982a and thermocouple 982b are described, other types of pressure and temperatures sensors may be incorporated in addition to, or in lieu of, strain gauge 982a and thermocouple 982b.

Coffee bean receptacle 980b is configured to contain ground coffee. The ground coffee may be tamped or otherwise compressed to form a coffee puck. Heating coil assembly 980c may be arranged substantially adjacent to coffee beam receptacle 980b to effectively heat liquid as the liquid passes from a liquid chamber (not shown) through a coffee puck contained in coffee bean receptacle 980b.

Heating coil assembly 980c may include a heating coil that has an overall shape of a Fermat spiral. The coil may be a wire or a tube that is bent or otherwise shaped as a Fermat spiral. In one embodiment, screen 980a may be shaped in a Fermat spiral such that openings defined in the screen are arranged in a Fermat spiral. When openings, as for example substantially circular openings, are arranged in a Fermat spiral, the openings may be aligned with the heating coil shaped as a Fermat spiral. When screen 980a is shaped as a Fermat spiral, strain gauge 982a may effectively be integrated into the Format spiral.

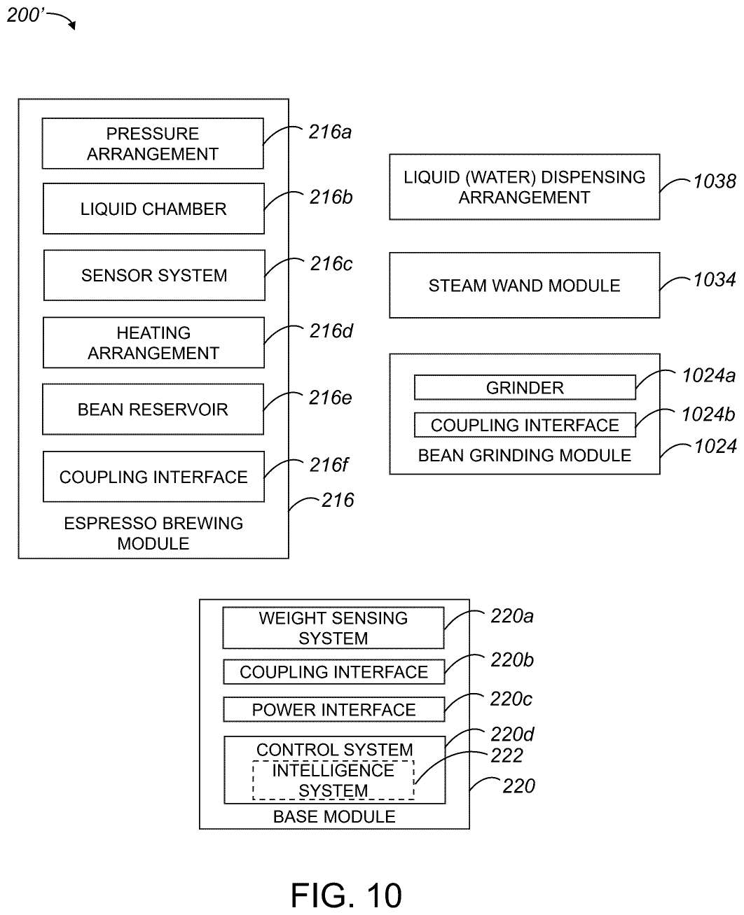

An overall process of creating a drink that includes espresso may include, but is not limited to including, grinding coffee beans, steaming milk, and/or obtaining water. In one embodiment, a modular espresso system may include accessories, attachments, or components which are suitable for grinding coffee beans, steaming milk, and obtaining water. The design and, hence, aesthetics of the various accessories, attachments, or components may vary widely. FIG. 10 is a block diagram representation of a modular espresso brewing system, e.g., modular espresso brewing system 200 of FIG. 2A, which includes accessory modules in accordance with an embodiment. Modular brewing system 200′ includes espresso brewing module 216 and base module 220. Modular brewing system 200′ may also include a bean grinding module 1024, a steam wand module 1034, and a liquid or water dispensing arrangement 1038.

Bean grinding module 1024 includes a grinder 1024a and a coupling interface 1024b. Grinder 1024a is configured to obtain whole coffee beans and to grind the whole coffee beans into ground coffee. The speed of an actuator included in grinder 1024a may be adjustable or variable to enable the grind size or texture, e.g., coarseness, of the ground coffee to be selected by a user. Coupling interface 1024b is arranged to enable bean grinding module 1024 to effectively draw power from base module 220. In one embodiment, coupling interface 1024b is configured to essentially attach to base module 220 through coupling interface 220b to draw power from power interface 220c when bean grinding module 1024 is in use.

Steam wand module 1034 is configured to cooperate with brewing module 216 to direct steam generated when heating arrangement 216d boils liquid contained in chamber 216b for use to steam milk and/or to create milk froth for espresso drinks. For example, steam wand module 1034 may be shaped to engage heating arrangement 216d when water contained in chamber 216b is boiling such that steam generated by the boiling water may effectively flow through steam wand module 1034 and be substantially directed or guided into a vessel containing milk to steam the milk and/or to create milk froth. In one embodiment, heating arrangement 216d may include a heating coil assembly shaped similarly to heating coil assembly 870 of FIG. 8, and steam wand module 1034 may be shaped to engage a heating coil assembly 870. In such an embodiment, steam wand module 1034 may also include a wand or nozzle end through which steam may effectively exit steam wand module 1034.

Water dispensing arrangement 1038 may be configured to at least partially store water, or any other liquid, such that water may be provided to chamber 216b when water is needed. Water dispensing arrangement 1038 may be a reservoir that is arranged to provide water through the use of a pump, or through the use of gravity. For example, water dispensing arrangement 1038 may include a water spout that may be positioned over brewing module 216. In one embodiment, water dispensing arrangement 1038 a water line inlet to obtain water and a retractable water spout which may rotate over chamber 216b when brewing module 216 is open to fill chamber 216b, and them may rotate away from chamber 216b after chamber 216b is filled.

In one embodiment, base module 220 may be configured with features, e.g., physical or mechanical features, which are configured to support or to house bean grinding module 1024, steam wand module 1034, and/or water dispensing arrangement 1038 when bean grinding module 1024, steam wand module 1034, and/or water dispensing arrangement 1038 are not in use. In such an embodiment, base module 220 may further be configured with features that engage espresso brewing module 216 when espresso brewing module 216 is not in use.

It should be appreciated that other mechanisms and/or attachments may be included in espresso brewing system 200′ in addition to, or in lieu of, bean grinding module 1-24, steam wand module 1034, and liquid dispensing arrangement 1038. For example, espresso brewing system 200′ may include a vacuum sealing module that is configured to effectively pull a negative pressure on a custom container or bean holding bag for the purpose of increasing the shelf life of coffee beans. Espresso brewing system 200′ may also include a pour over module which enables a liquid to be heated by heating arrangement 216d, and utilizes pressure arrangement 216a to push liquid up through a spout that faces downwards to essentially shower carefully dosed water pour over a pour over coffee apparatus such as a porcelain cone with a filter that holds ground beans and is positioned on top of a cup. Such a pour over system may be positioned on weight sensing system 220a to enable measurements associated with a cup of pour over coffee to be measured and effectively monitored.

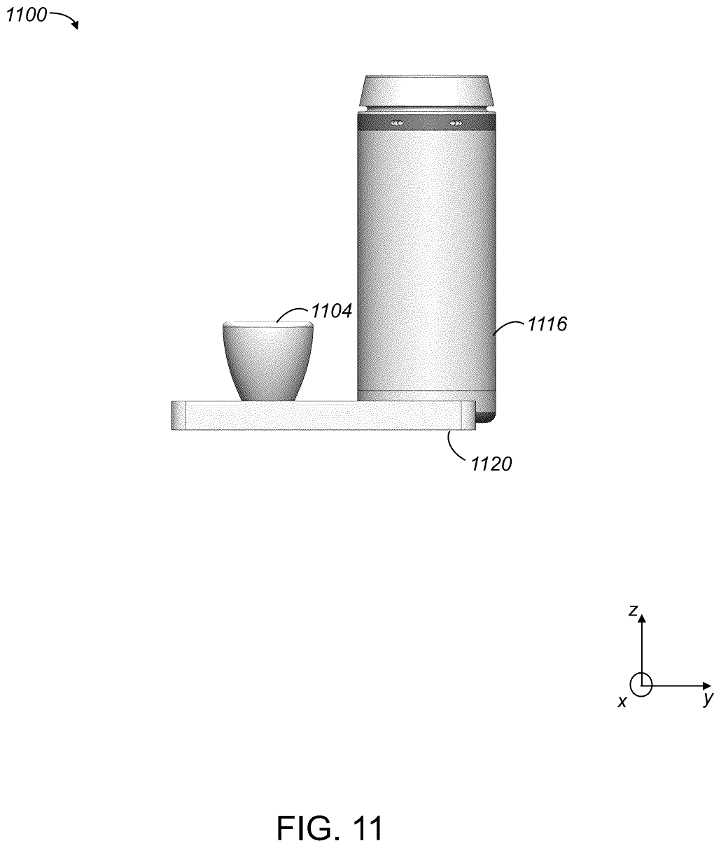

FIG. 11 is a diagrammatic representation of a modular espresso brewing system which includes features arranged to support an espresso brewing module in a storage orientation in accordance with an embodiment. A modular espresso brewing system 1100 includes a brewing module 1116 which is configured to be supported in a base module 1120 when brewing module 1116 is not in use to brew espresso. As shown, an espresso cup 1104 may also be substantially stored on base module 1120.

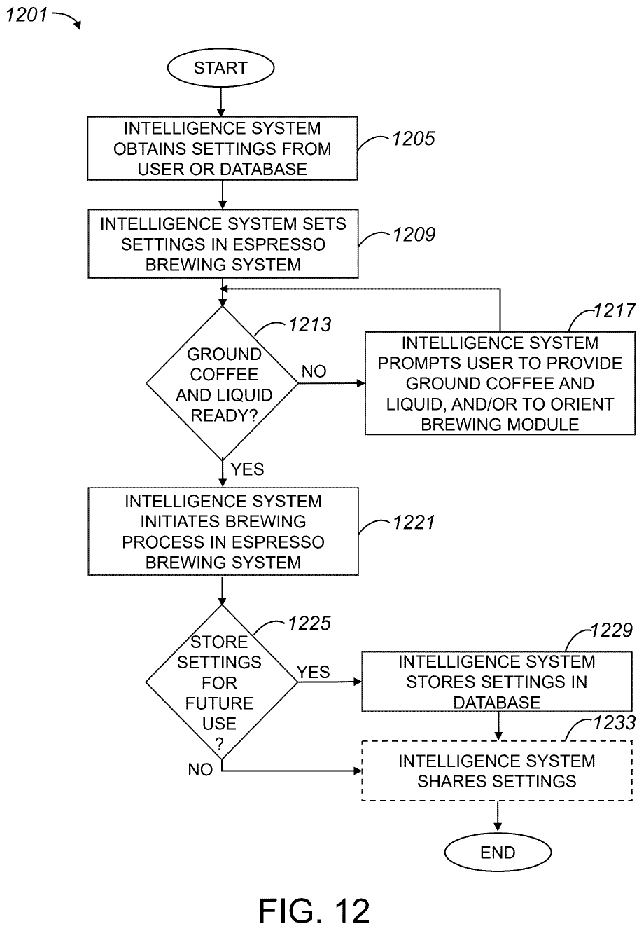

In one embodiment, a modular espresso brewing system may include intelligence or software which enables the brewing system to be substantially controlled. For example, intelligence may enable a user to select parameters used to brew his/her/their espresso to desired specifications. The intelligence may also enable parameters or settings to be stored for future use. FIG. 12 is a process flow diagram which illustrates a method of utilizing intelligence associated with a modular espresso brewing system in accordance with an embodiment. A method 1201 of utilizing intelligence associated with a modular espresso brewing system begins at a step 1205 in which an intelligence system of a brewing system obtains settings or parameters. The settings may be obtained from a user, e.g., when the user uses a user interface (UI) of the intelligence system to enter the settings, and/or from a database which may store settings that were previously selected by the user. It should be appreciated that the database may also store settings such as “suggested” or “popular” settings generally used by users who brew espresso using substantially the same, or similar, brewing systems.

In a step 1209, the intelligence system sets or otherwise implements the obtained settings in the brewing system. For example, the intelligence system may effectively program the settings such that the brewing system may brew a shot of espresso to a selected temperature, and/or at a selected pressure.

After the intelligence system sets the settings, a determination is made in a step 1213 as to whether ground coffee and liquid, as for example water, are ready to brew espresso. In other words, it is determined whether a suitable amount of ground coffee and a suitable amount of liquid have been provided to a brewing module or cylinder of the brewing system. Such a determination may be made using sensors of the brewing system. It should be appreciated that determining whether ground coffee and liquid are ready may also include determining whether the brewing module is oriented in a brew orientation.

If the determination in step 1213 is that the ground coffee and liquid are not ready, the intelligence system may prompt a user to provide the ground coffee and liquid, and/or to position the brewing module in a brew orientation, in a step 1217. Once the intelligence system prompts the user, process flow returns to step 1213 in which it is determined whether the ground coffee and liquid are ready.

Alternatively, if it is determined in step 1213 that the ground coffee and liquid are ready, the implication is that espresso is ready to be brewed. Accordingly, in a step 1221, the intelligence system initiates a brewing process in the espresso brewing system. Initiating the brewing process may include, but is not limited to including, providing power to a heating arrangement to heat the liquid and actuating an actuator to extend a piston arrangement to apply pressure to the liquid to force the liquid through the ground coffee.

After the espresso is brewed, it is determined in a step 1225 whether the settings used to brew the espresso are to be stored for future use. In one embodiment, the user may be prompted to determine whether the settings are to be stored in a database such that the user may access the settings in the future. In another embodiment, the user may have default preferences which indicate either that the settings are substantially always to be stored or substantially never to be stored.

If it is determined that the settings are to be stored for future use, process flow proceeds to a step 1229 in which the intelligence system stores the settings in a database. Then, in an optional step 1233, the intelligence system may share the settings. Sharing the setting may include, but is not limited to including, notifying the user of the settings through a text or an email, notifying a group identified by the user of the settings through a text or an email, sharing the settings in a social media platform with information about the user, and/or sharing the settings in a social media platform substantially without identifying the user. The method of utilizing intelligence associated with a modular espresso brewing system is then completed.

Alternatively, if it is determined in step 1225 that the settings are not to be stored for future use, the indication is that the user is not interested in collecting information about the settings he/she/they used to brew espresso. When the settings are not to be stored, process flow moves to optional step 1233 in which the intelligence system may share the settings.

As mentioned above, a puck screen such as puck screen 774 of FIGS. 7A and 7B may include a temperature sensor such as a thermocouple integrated thereon. With reference to FIGS. 13A and 13B, one embodiment of a pick screen with an integrated thermocouple will be described in accordance with an embodiment, FIG. 13A is a diagrammatic representation of a puck screen, and FIG. 13B is a zoomed in representation of a portion of the puck. A puck screen 1374, which may be formed from a material such as metal, includes a screen portion 1374a, a frame or bezel 1374b that is arranged to support screen portion 1374a, and a thermocouple 1374c integrated into or substantially embedded in screen portion 1374a. Screen portion 1374a may include an array of substantially circular openings 1376 which effectively form a screen or a mesh. Thermocouple 1374c is configured to effectively measure or to determine a temperature of liquid as the liquid flows through openings 1376.

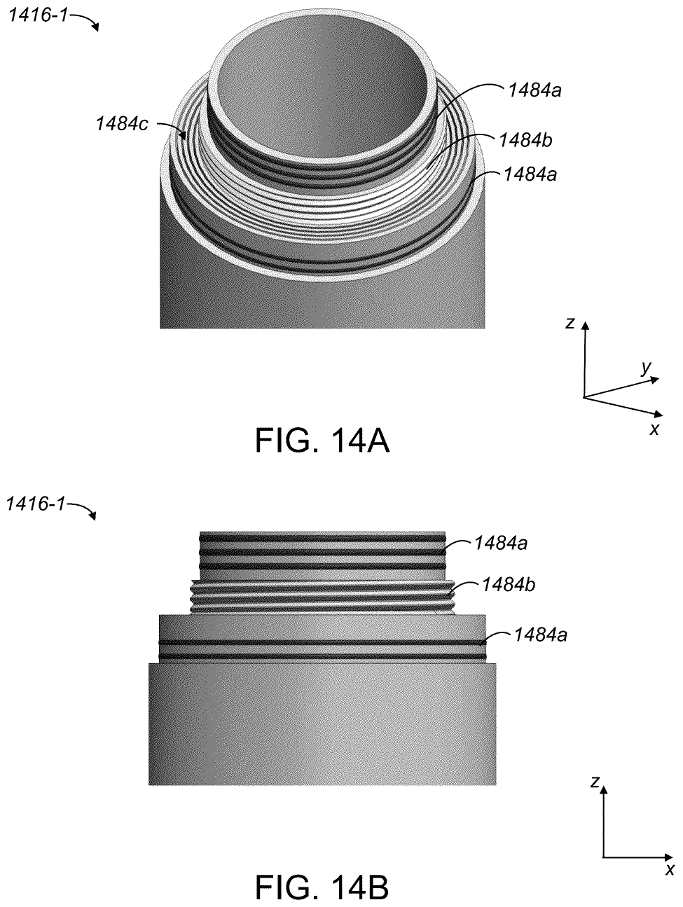

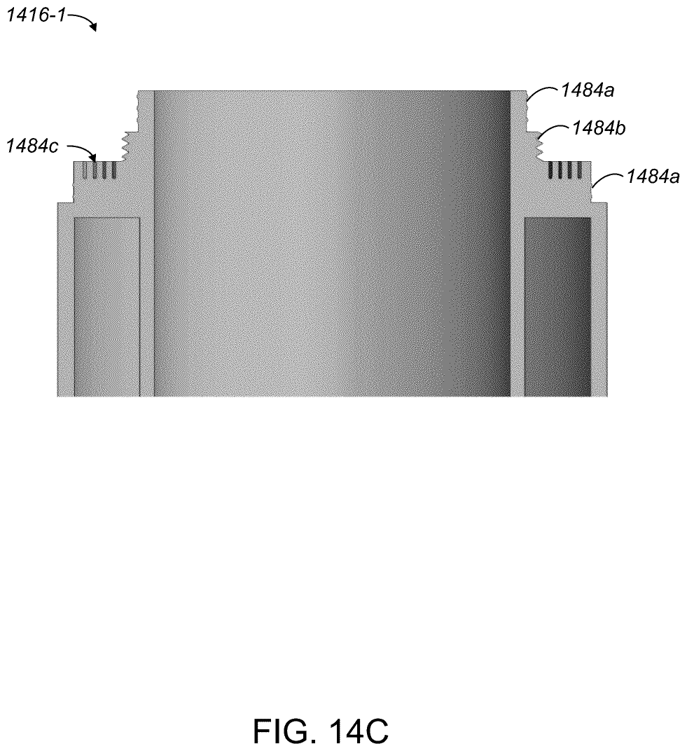

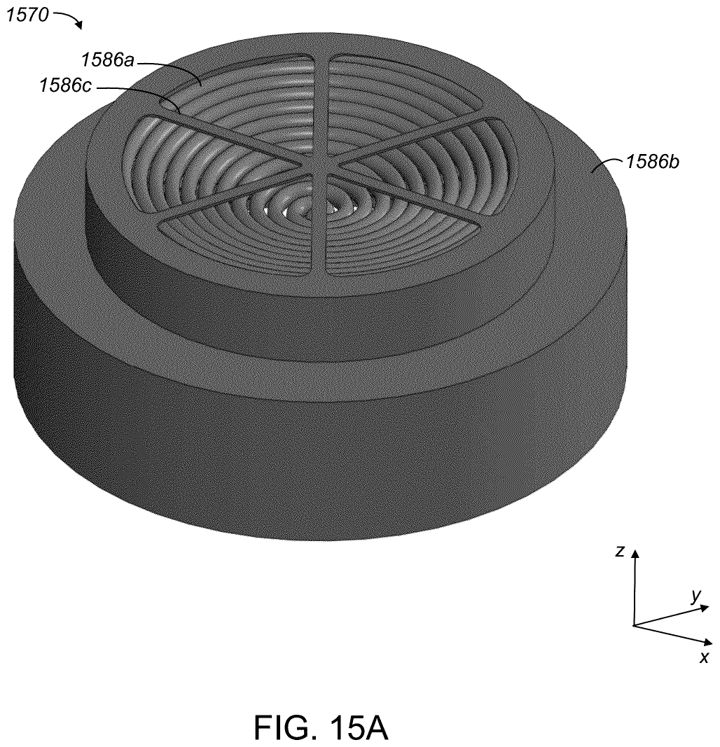

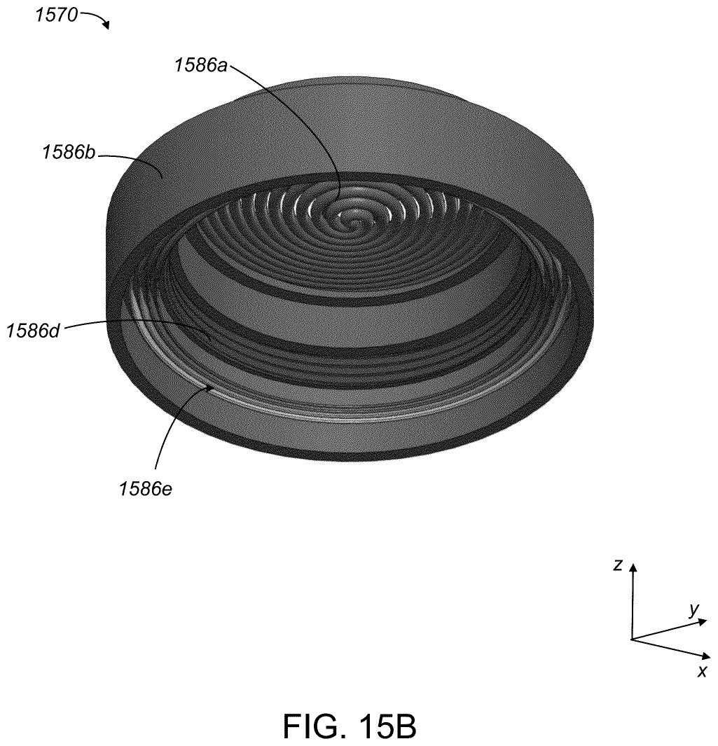

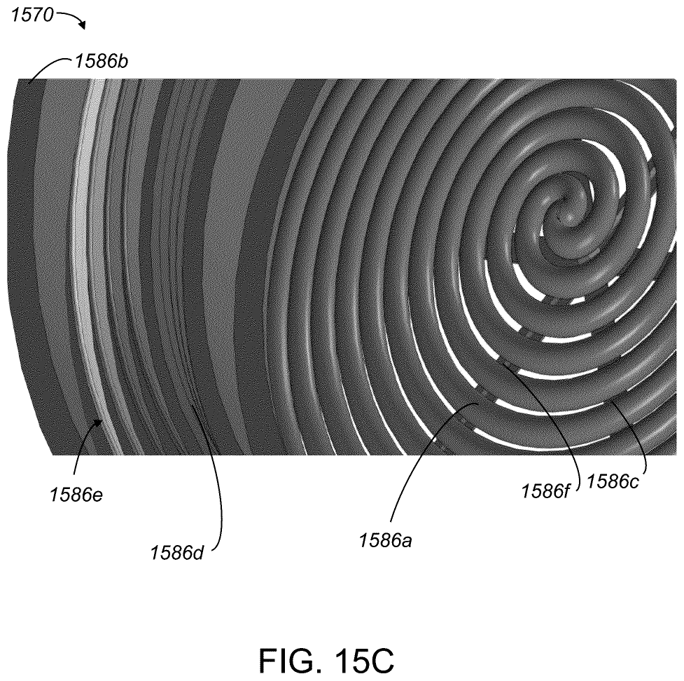

While a puck screen may include one or more sensors as discussed above, a puck screen may instead be substantially passive. When a puck screen is passive, or does not include sensors, a sensor such as a thermocouple may be substantially incorporated into a cover or a top portion of a brewing module, and may draw power from a bottom potion or a cylinder of the brewing module. With reference to FIGS. 14A-C, a bottom portion or a cylinder of a brewing module which is configured to engage a heating arrangement which includes a thermocouple will be described in accordance with an embodiment. A bottom portion 1416-1 of a brewing module is arranged to accommodate a plurality of O-rings 1484a, and includes threads 1484b configured to engage a heating arrangement, as for example a heating and coil assembly (not shown, of a brewing module. One suitable heating arrangement will be described below with respect to FIGS. 15A-C. It should be appreciated that bottom portion 1416-1 includes a liquid chamber, and is a “bottom” of a brewing module when the brewing module is in a fill orientation. The number of O-rings 1484a may vary, although approximately five O-rings are shown for case of illustration.

Bottom portion 1416-1 also includes grooved ring sockets 1484c which are each substantially separated by a diameter size to carry power. For example, ring sockets 1484c may include approximately four ring socket such that two ring sockets carry power for a heating coil and two ring sockets carry power for a thermocouple when a heating arrangement (not shown) is engaged with bottom portion 1416-1. Wires (not shown) which are coupled to ring sockets 1484c may pass through an open wall of bottom portion 1416-1, and attached to a PCB power control board (not shown).

Referring next to FIGS. 15A-C. a heating arrangement which may engage with bottom portion 1416-1 of FIGS. 14A-C will be described in in accordance with an embodiment. A heating arrangement 1570 includes a heating coil 1586a, a frame 1586b, support structures 1586c, threads 1586d, terminals 1586e, and a thermocouple 1586f. Heating arrangement 1570 may engage with bottom portion 1416-1 of FIGS. 14A-C when threads 1586d effectively mate with threads 1484b of bottom portion 1416-1, e.g., when heating arrangement 1570 screws into bottom portion 1416-1.

Thermocouple 1586f may be carried on support structures 1586c or spokes such that thermocouple 1586f is disposed between heating coil 1586a and support structures 1586c. Terminals 1586e are arranged to complete a circuit for thermocouple 1586f which may be a two type metal junction positioned substantially above an approximate middle of heating coil 1586a. When heating arrangement 1570 is engaged with bottom portion 1416-1 of FIGS. 14A-C, terminals 1586e and heating coil 1586a may obtain power through interfacing with ring sockets 1484c.

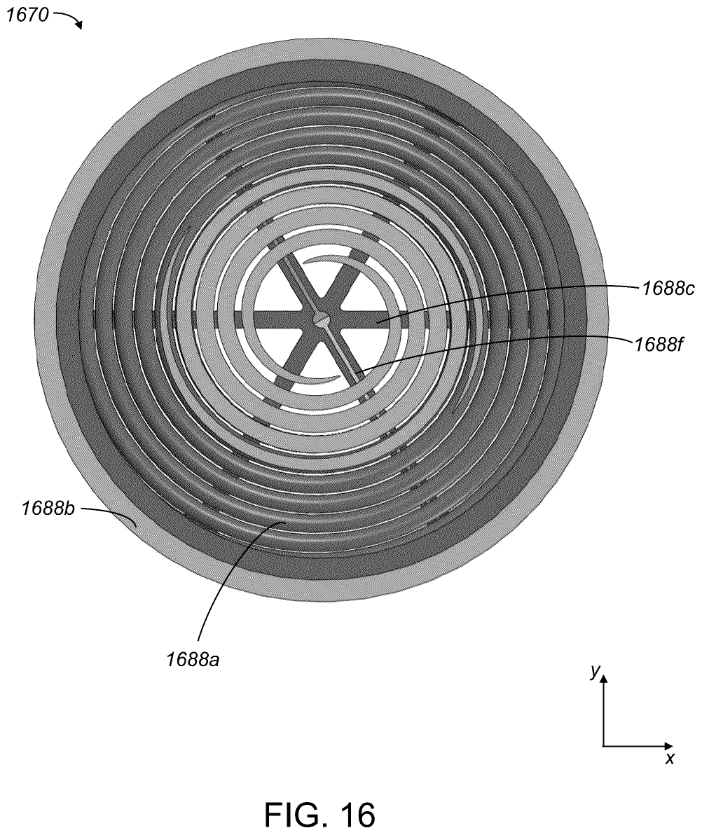

FIG. 16 is a diagrammatic representation of a heating arrangement which includes a thermocouple assembly in accordance with an embodiment. A heating arrangement 1670 includes a heating coil 1688a supported by a frame 1688b which includes support structures 1688c configured to effectively hold a thermocouple 1688f such that thermocouple 1688f is positioned substantially above a middle of heating coil 1688a. Heating coil 1688a is shown in a cutaway orientation for case of illustration.

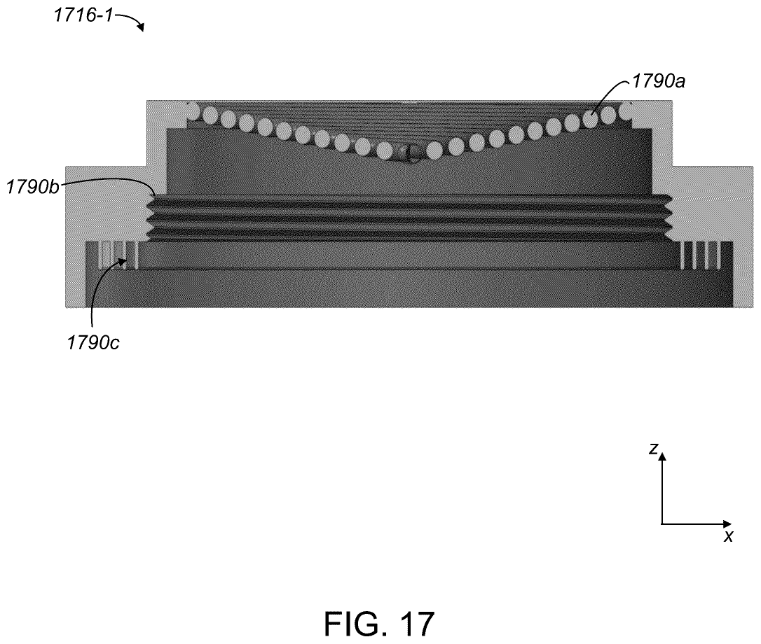

FIG. 17 is a diagrammatic side view representation of a heating arrangement which includes a thermocouple and is assembled to a bottom portion of a brewing module in accordance with an embodiment. A bottom portion 1716-1 or cylinder includes threads 1790b arranged to mate with threads (not shown) included in a heating arrangement that includes a heating coil 1790a. When the heating arrangement is substantially screwed into bottom portion 1716-1, plugs 1790c of the heating arrangement may be arranged to plug into four sockets or ring grooves located on bottom portion 1716-1 such that power may be provided to heating coil 1790a and to a thermocouple (not shown).

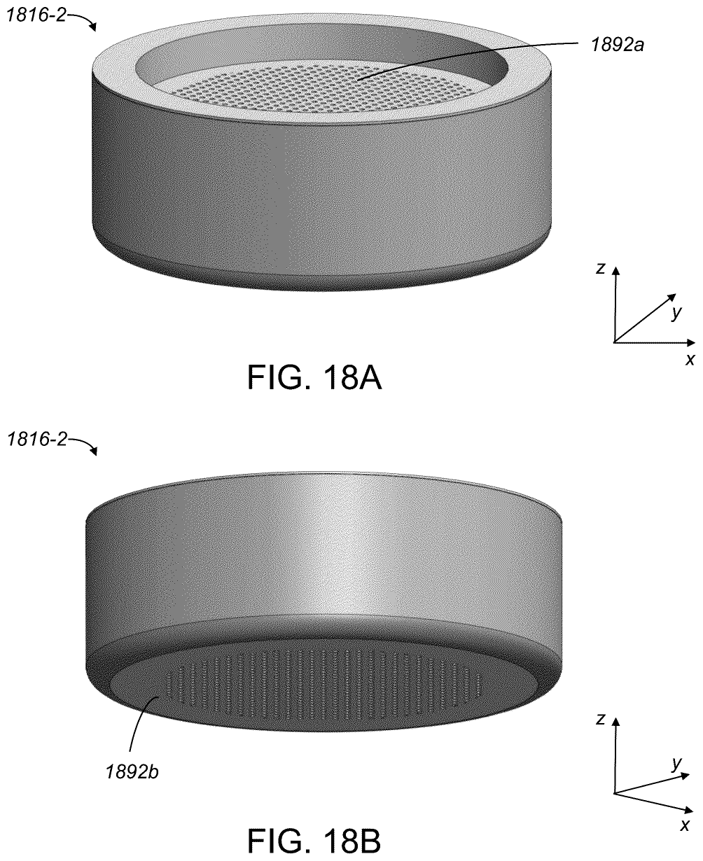

FIG. 18A is a first view of a portafilter assembly in accordance with an embodiment, and FIG. 18B is a second view of a portafilter assembly, e.g., portafilter assembly 1816-2 of FIG. 18A, in accordance with an embodiment. A portafilter assembly 1816-2 is configured to be positioned over a heating arrangement when a heating arrangement is positioned over a bottom portion of a brewing module. Portafilter assembly 1816-2 is passive, and does not include sensors. Portafilter assembly 1816-2 may hold or otherwise contain a coffee puck between a first screen 1892a and a puck screen 1892b.

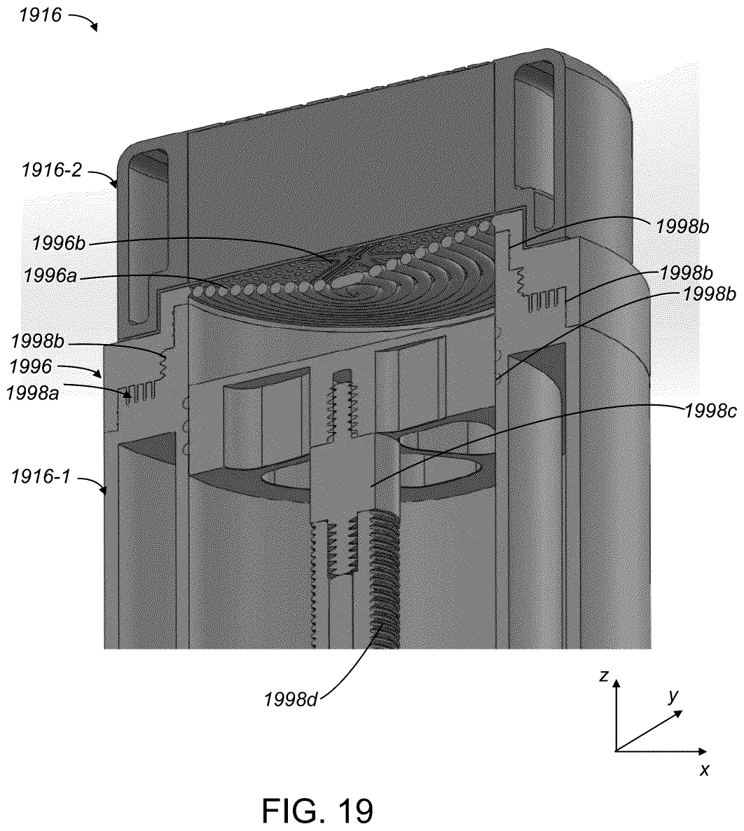

Referring next to FIG. 19, a brewing module which includes a bottom portion which may be engaged with a heating arrangement and a portafilter will be described in accordance with an embodiment A brewing module 1916, which is shown in a fill orientation, is generally a double-walled cylinder which includes a vacuum between the double walls. Brewing module 1916 includes a bottom portion 1916-1 and a portafilter 1916-2 Portafilter 1916-2 is arranged to contain a coffee puck. A heating arrangement 1996, which includes a heating coil 1996a and a thermocouple 1996b, is arranged between bottom portion 1916-2 and portafilter 1916-2.

Electrical connections 1998a are created when heating arrangement 1996 and bottom portion 1916-1 are engaged. O-rings 1998b are arranged to provide seals between heating arrangement 1996 and bottom portion 1916-1. A pressure sensor 1998c may be arranged on a piston drive screw 1998d which is driven by an actuator (not shown) to force a liquid through heating coil 1996a and through a coffee puck contained in portafilter 1916-2 when brewing module 1916 is in a brew orientation. It should be appreciated that pressure sensor 1998c may generally include a cable that passes through a center of piston drive screw. 1998d

Although only a few embodiments have been described in this disclosure, it should be understood that the disclosure may be embodied in many other specific forms without departing from the spirit or the scope of the present disclosure. By way of example, the steps included in the methods described above may vary without departing from the spirit or the scope of the disclosure. In general, the steps associated with the methods described above are not limited to being performed in the order indicated.

As mentioned above, a heating coil assembly may be substantially coupled to a puck screen. In one embodiment, a heating coil assembly may instead be a separate component that may attach to an open end of a brewing module or cylinder. In such an embodiment, the heating coil assembly may be connected by handles for ease of removing and assembling the heating coil assembly into the brewing module.

While a heating coil has been described as being configured in a coiled or spiral shape, as for example such that a tube is coiled in a Fermat spiral shape, the configuration of a heating coil may vary. In addition, while a heating coil has been described as being formed from a flexible material such silicone rubber, metal foil, and/or polyimide, a heating coil may be formed or fabricated from other suitable materials.

The location of a heating coil within a brewing module may vary. For example, the heating coil may essentially be integrated into a portion of the brewing module that holds liquid. That is, a heating coil may be substantially incorporated into a second module of a brewing module that includes a liquid chamber.

To facilitate the ability to maintain, as for example to clean, a brewing module, a portion of the brewing module which is configured to include a power interface may include a block of input/output wires or cables which are provided substantially out of a back or rear surface of the brewing module as mentioned above. A substantially waterproof cover or cap which is provided with O-rings may be fastened, e.g., removably attached to or screwed onto, the portion of the brewing module which includes a power interface at substantially the same location where a cable harness for may be removably attached.

While sensors such as a thermocouple and a strain gauge have been described as being incorporated into a puck screen, it should be understood that sensors are not limited to being incorporated into a puck screen. For instance, a pressure sensor such as a strain gauge or a transducer may be incorporated into or onto a piston head.

To provide an intelligence system, an espresso brewing system may include a computing device and/or be in communication with a computing device. Such a computing device may be any apparatus that may include one or more processor(s), one or more memory element(s), storage, a bus, one or more network processor unit(s) interconnected with one or more network input/output (I/O) interface(s), one or more I/O interface(s), and control logic. In various embodiments, instructions associated with logic for the computing device may overlap in any manner and are not limited to the specific allocation of instructions and/or operations described herein. In at least one embodiment, processor(s) is/are at least one hardware processor configured to execute various tasks, operations and/or functions for the computing device according to software and/or instructions configured for the computing device. Processor(s) may execute any type of instructions associated with data to achieve the operations detailed herein.

In some aspects, the techniques described herein relate to an apparatus including: a first module, the first module including a first receptacle and a second receptacle, the first receptacle configured to contain a liquid and a second receptacle configured to contain coffee beans, the first module further including a heating arrangement, the heating arrangement being at least partially positioned between the first receptacle and the second receptacle; and a second module, the second module being configured to support the first module and to provide power to the heating arrangement when the first module is supported on the second module.

In some aspects, the techniques described herein relate to an apparatus wherein the heating arrangement includes a heating coil, the heating coil being positioned between the first receptacle and the second receptacle, wherein the power provided to the heating arrangement causes the heating coil to be heated.

In some aspects, the techniques described herein relate to an apparatus wherein the heating coil includes a tube that is coiled in a Fermat spiral shape.

In some aspects, the techniques described herein relate to an apparatus wherein the tube is further coiled in a conical shape, and wherein the tube is formed from a flexible material.

In some aspects, the techniques described herein relate to an apparatus wherein the heating coil is positioned to heat liquid as the liquid flows from the first receptacle into the second receptacle.

In some aspects, the techniques described herein relate to an apparatus wherein the first module further includes a piston arrangement, the piston arrangement being configured to extend to apply a pressure to cause the liquid to flow from the first receptacle into the second receptacle.

In some aspects, the techniques described herein relate to an apparatus wherein the first module further includes a screen and a sensor arrangement, the screen being arranged between the heating arrangement and the second receptacle, wherein the sensor is a temperature sensor.

In some aspects, the techniques described herein relate to an apparatus wherein the temperature sensor is a thermocouple, and wherein the thermocouple is integrated onto the screen.

In some aspects, the techniques described herein relate to an apparatus wherein the second module includes an arm, the arm a second being configured to movably support the first module.

In some aspects, the techniques described herein relate to a modular espresso brewing system including: a brewing module, the brewing module including a liquid chamber and a coffee bean receptacle, the liquid chamber being arranged to contain a liquid and the coffee bean receptacle being arranged to contain ground coffee beans, wherein the brewing module includes a heating arrangement configured to heat the liquid, the heating arrangement being at least partially arranged between the liquid chamber and the coffee bean receptacle to heat the liquid as the liquid flows from the liquid chamber into the coffee bean receptacle; and a base module, the base module being configured to support the brewing module and to provide power to the heating arrangement when the brewing module is supported on the base module.

In some aspects, the techniques described herein relate to a modular espresso brewing system further including: a grinding module, the grinding module being configured to be supported on an arm of the base module and to obtain power from the base module, wherein the grinding module is arranged to grind coffee beans to create the ground coffee beans.

In some aspects, the techniques described herein relate to a modular espresso brewing system further including: a liquid dispensing arrangement, the liquid dispensing arrangement being configured to be supported on the base module and to provide the liquid to the liquid chamber.

In some aspects, the techniques described herein relate to a modular espresso brewing system further including: a steam wand module, the steam wand module being arranged to be coupled to the brewing module to direct steam generated when the heating arrangement heats the liquid from the brewing module.

In some aspects, the techniques described herein relate to a modular espresso brewing system wherein the base module includes a weight sensing system configured to provide a weight measurement associated with the brewing module.

In some aspects, the techniques described herein relate to a modular espresso brewing system wherein the brewing module includes a sensor system, the sensor system including a temperature sensor, the temperature sensor being positioned between the heating arrangement and the coffee bean receptacle and configured to measure a temperature of the liquid.

In some aspects, the techniques described herein relate to a modular espresso brewing system wherein the brewing module further includes a screen, the screen being arranged between the heating arrangement and the coffee bean receptacle, and wherein the temperature sensor is a thermocouple integrated into the screen.

In some aspects, the techniques described herein relate to a brewing apparatus including: a liquid chamber arranged to contain a liquid; a bean reservoir arranged to contain coffee beans; a pressure arrangement, the pressure arrangement including a piston, the piston being arranged to be extended through the liquid chamber to apply a pressure to push the liquid out of the liquid chamber and through the bean reservoir; a heating coil arranged between the liquid chamber and the bean reservoir, wherein the heating coil is configured to heat the liquid as the liquid is pushed from the liquid chamber through the bean reservoir by the piston; and a temperature sensor, the temperature sensor arranged between the heating coil and the bean reservoir, wherein the temperature sensor measures a temperature of the liquid.

In some aspects, the techniques described herein relate to a brewing apparatus further including a screen disposed between the heating coil and the bean reservoir, wherein the temperature sensor is a thermocouple, and wherein the thermocouple is integrated into a screen.

In some aspects, the techniques described herein relate to a brewing apparatus wherein the heating coil includes a tube that is coiled in a Fermat spiral shape.

In some aspects, the techniques described herein relate to a brewing apparatus wherein the tube is formed from one selected from a group including silicone rubber, metal foil, and polyimide.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of can be represented using the’ (s)′ nomenclature (e.g., one or more element(s)).

As used herein, the terms “approximately,” “generally,” “substantially,” and so forth, are intended to convey that the property value being described may be within a relatively small range of the property value, as those of ordinary skill would understand. For example, when a property value is described as being “approximately” equal to (or, for example, “substantially similar” to) a given value, this is intended to convey that the property value may be within +/−5%, within +/−4%, within +/−3%, within +/−2%, within +/−1%, or even closer, of the given value.

Similarly, when a given feature is described as being “substantially parallel” to another feature, “generally perpendicular” to another feature, and so forth, this is intended to convey that the given feature is within +/−5%, within +/−4%, within +/−3%, within +/−2%, within +/−1%, or even closer, to having the described nature, such as being parallel to another feature, being perpendicular to another feature, and so forth. Mathematical terms, such as “parallel” and “perpendicular,” should not be rigidly interpreted in a strict mathematical sense, but should instead be interpreted as one of ordinary skill in the art would interpret such terms. For example, one of ordinary skill in the art would understand that two lines that are substantially parallel to each other are parallel to a substantial degree, but may have minor deviation from exactly parallel.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. An apparatus comprising:
a first module, the first module including a first receptacle and a second receptacle, the first receptacle configured to contain a liquid and a second receptacle configured to contain coffee beans, the first module further including a heating arrangement, the heating arrangement being at least partially positioned between the first receptacle and the second receptacle; and
a second module, the second module being configured to support the first module and to provide power to the heating arrangement when the first module is supported on the second module.

2. The apparatus of claim 1 wherein the heating arrangement includes a heating coil, the heating coil being positioned between the first receptacle and the second receptacle, wherein the power provided to the heating arrangement causes the heating coil to be heated.

3. The apparatus of claim 2 wherein the heating coil includes a tube that is coiled in a Fermat spiral shape.

4. The apparatus of claim 3 wherein the tube is further coiled in a conical shape, and wherein the tube is formed from a flexible material.

5. The apparatus of claim 2 wherein the heating coil is positioned to heat liquid as the liquid flows from the first receptacle into the second receptacle.

6. The apparatus of claim 5 wherein the first module further includes a piston arrangement, the piston arrangement being configured to extend to apply a pressure to cause the liquid to flow from the first receptacle into the second receptacle.

7. The apparatus of claim 2 wherein the first module further includes a screen and a sensor arrangement, the screen being arranged between the heating arrangement and the second receptacle, wherein the sensor is a temperature sensor.

8. The apparatus of claim 7 wherein the temperature sensor is a thermocouple, and wherein the thermocouple is integrated onto the screen.

9. The apparatus of claim 1 wherein the second module includes an arm, the arm a second being configured to movably support the first module.

10. A modular espresso brewing system comprising:
a brewing module, the brewing module including a liquid chamber and a coffee bean receptacle, the liquid chamber being arranged to contain a liquid and the coffee bean receptacle being arranged to contain ground coffee beans, wherein the brewing module includes a heating arrangement configured to heat the liquid, the heating arrangement being at least partially arranged between the liquid chamber and the coffee bean receptacle to heat the liquid as the liquid flows from the liquid chamber into the coffee bean receptacle; and
a base module, the base module being configured to support the brewing module and to provide power to the heating arrangement when the brewing module is supported on the base module.

11. The modular espresso brewing system of claim 10 further including:
a grinding module, the grinding module being configured to be supported on an arm of the base module and to obtain power from the base module, wherein the grinding module is arranged to grind coffee beans to create the ground coffee beans.

12. The modular espresso brewing system of claim 10 further including:
a liquid dispensing arrangement, the liquid dispensing arrangement being configured to be supported on the base module and to provide the liquid to the liquid chamber.

13. The modular espresso brewing system of claim 10 further including:
a steam wand module, the steam wand module being arranged to be coupled to the brewing module to direct steam generated when the heating arrangement heats the liquid from the brewing module.

14. The modular espresso brewing system of claim 10 wherein the base module includes a weight sensing system configured to provide a weight measurement associated with the brewing module.

15. The modular espresso brewing system of claim 10 wherein the brewing module includes a sensor system, the sensor system including a temperature sensor, the temperature sensor being positioned between the heating arrangement and the coffee bean receptacle and configured to measure a temperature of the liquid.

16. The modular espresso brewing system of claim 15 wherein the brewing module further includes a screen, the screen being arranged between the heating arrangement and the coffee bean receptacle, and wherein the temperature sensor is a thermocouple integrated into the screen.

17. A brewing apparatus comprising:
a liquid chamber arranged to contain a liquid;
a bean reservoir arranged to contain coffee beans;
a pressure arrangement, the pressure arrangement including a piston, the piston being arranged to be extended through the liquid chamber to apply a pressure to push the liquid out of the liquid chamber and through the bean reservoir;
a heating coil arranged between the liquid chamber and the bean reservoir, wherein the heating coil is configured to heat the liquid as the liquid is pushed from the liquid chamber through the bean reservoir by the piston; and
a temperature sensor, the temperature sensor arranged between the heating coil and the bean reservoir, wherein the temperature sensor measures a temperature of the liquid.

18. The brewing apparatus of claim 17 further including a screen disposed between the heating coil and the bean reservoir, wherein the temperature sensor is a thermocouple, and wherein the thermocouple is integrated into a screen.

19. The brewing apparatus of claim 17 wherein the heating coil includes a tube that is coiled in a Format spiral shape.

20. The brewing apparatus of claim 19 wherein the tube is formed from one selected from a group including silicone rubber, metal foil, and polyimide.
